(19) United States
(12) Patent Application Publication
(10) Pub. No.: US 2025/0067407 A1
(43) Pub. Date: Feb. 27, 2025

(54) DOWNLIGHT APPARATUS

(71) Applicant: XIAMEN ECO LIGHTING CO., LTD, Xiamen (CN)

(72) Inventors: Huiyong Huang, Xiamen (CN); Zhenyu Tang, Xiamen (CN); Shuxing Gao, Xiamen (CN)

(21) Appl. No.: 18/933,634

(22) Filed: Oct. 31, 2024

Related U.S. Application Data
(63) Continuation-in-part of application No. 18/212,759, filed on Jun. 22, 2023, now Pat. No. 12,163,641.
Application No. 18/212,759 is a continuation of application No. 17/471,042, filed on Sep. 9, 2021, now Pat. No. 11,761,596.

(30) Foreign Application Priority Data
Sep. 9, 2020 (CN) 202021962277.X
Sep. 9, 2020 (CN) 202021962480.7
Sep. 9, 2020 (CN) 202021962759.5
Sep. 9, 2020 (CN) 202021963435.3
Sep. 9, 2020 (CN) 202021963476.2
Sep. 10, 2020 (CN) 202021973305.8
Sep. 10, 2020 (CN) 202021973469.0
Sep. 10, 2020 (CN) 202021973704.4
Sep. 10, 2020 (CN) 202021973937.4
Sep. 10, 2020 (CN) 202021974013.6
Sep. 10, 2020 (CN) 202021974312.X
Sep. 10, 2020 (CN) 202021974314.9
Sep. 10, 2020 (CN) 202021974622.1

(51) Int. Cl. F21S 8/02; F21V 8/00; F21V 15/01; F21V 21/04; F21V 21/14; F21V 21/26; F21V 23/00; F21V 23/04; F21V 23/06; F21V 29/70; F21Y 115/10

(52) U.S. Cl. CPC F21S 8/026; F21S 8/02; F21V 15/01; F21V 21/04; F21V 21/14; F21V 21/26; F21V 23/003; F21V 23/007; F21V 23/04; F21V 23/06; F21V 29/70; G02B 6/0085; F21V 21/047; F21V 21/049; F21Y 2115/10

(57) ABSTRACT

A lighting apparatus includes a light source, a main body, a plurality of connecting sheets and a mounting frame. The light source is installed in the main body. An interior of the main body includes a fans assembly. A plurality of connecting sheets are disposed at a bottom portion of the main body. Each connecting sheet of the plurality of connecting sheets includes a first end mounted on a side wall of the main body and a second end extending in a direction away from the main body. The mounting frame is disposed below the main body for supporting and fixing the main body. The mounting frame includes a plurality of mounting slots. The plurality of mounting slots are positioned to match positions of the plurality of connecting sheets.

### RELATED APPLICATION

The present application is a continuation-in-part of U.S. application Ser. No. 18/212,759, which is a continued application of U.S. application Ser. No. 17/471,042.

### FIELD

The present invention is related to a downlight apparatus, and more particularly related to a downlight apparatus with an easy assembly structure.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

Downlight devices are widely used in various places. It is beneficial to find out improvements of downlight devices to provide a more convenient and more safe downlight products.

In addition, it is important to provide a convenient assembly structure. The structure includes complexity reducing during manufacturing and during installation. Downlight devices are widely used in various places. It is beneficial to find out improvements of downlight devices to provide a more convenient and more safe downlight products.

In addition, it is important to provide a convenient assembly structure. The structure includes complexity reducing during manufacturing and during installation. Downlight devices are widely used in various places. It is beneficial to find out improvements of downlight devices to provide a more convenient and more safe downlight products.

In addition, it is important to provide a convenient assembly structure. The structure includes complexity reducing during manufacturing and during installation. Downlight devices are widely used in various places. It is beneficial to find out improvements of downlight devices to provide a more convenient and more safe downlight products.

In addition, it is important to provide a convenient assembly structure. The structure includes complexity reducing during manufacturing and during installation.

### SUMMARY

In some embodiments, a downlight apparatus includes a light source, a light holder, a driver box, a fixing bracket and two torsion springs.

The light holder is used for placing the light source. The light holder has a first side defining a light opening.

The driver box is placed on a second side of the light holder.

The driver box contains a driver for converting an external power to a driving current supplied to the light source to emit a light from the light opening.

The fixing bracket is coupled to the light holder for fixing to an installation cavity.

The fixing bracket has a bottom plate and two connector plate.

The bottom plate is fixed to the second side of the light holder.

The two connector plates are disposed vertically to the bottom plate.

Each connector plate has two side units.

Each torsion spring has an elastic center and two arms.

The two arms are elastically spreading with different angles with respect to the elastic center.

The two torsion springs are attached to a lateral side of the two connector plates.

Either the two torsion springs are elastically squeezed to engage the installation cavity or the side units of the connector plates are elastically squeezed to engage the installation cavity.

In some embodiments, the installation cavity is a cavity in a junction box.

In some embodiments, the bottom plate of the fixing bracket has a central hole for the driver box to pass through.

In some embodiments, the driver box has an elastic hook.

When the central hole of the bottom plate passes reaches a bottom edge of the driver box, the elastic hook locks the bottom plate to the second side of the light holder.

In some embodiments, the bottom plate has multiple connection holes for fixing the bottom plate to the installation cavity with bracket connectors.

In some embodiments, the connection hole is a key hole with an larger entrance and a smaller siding track.

The bracket connector enters the larger entrance and then stays in the sliding track to fix the bottom bracket to the installation cavity.

In some embodiments, the connector plates are detachable from the bottom plate.

In some embodiments, the connector plates are fixed to the bottom plate with screws.

In some embodiments, the two side units are two folded plates folding with respect to a main body of the connector plate.

In some embodiments, a folding angle of the folded plate with respect to the main body of the connector plate is larger than 90 degrees.

In some embodiments, the connector plates are made as the same metal piece as the bottom plate and are folded vertically with respect to the bottom plate.

In some embodiments, the fixing bracket has a scraper for scraping a portion of electric insulation layer on the second side of the light holder for electrically connecting the light holder to ground.

In some embodiments, the light source includes multiple LED modules distributed in a first range.

The bottom plate has a larger size than the first range to carry heat of the first range outside the first range.

In some embodiments, the bottom plate has multiple bracket connectors.

The second side of the light holder has corresponding multiple holder connectors.

The bracket connectors are respectively slided to engage the holder connectors by rotating the light holder with respect to to the fixing bracket.

In some embodiments, a reverse lock structure prevents the bracket connector accidently escape from the holder connector.

In some embodiments, the bracket connector is vertical to the holder connector.

In some embodiments, a top plate of the driver box has a wire socket and a manual switch.

The wire socket is connected to a power wire and the manual switch is used for adjusting a setting of the light source.

In some embodiments, the top plate of the driver box further has a rotation switch for continuously setting a maximum light intensity of the light source.

In some embodiments, the light source has a light source plate mounted with LED modules.

The light source plate is connected to the light holder to connect to the ground.

In some embodiments, multiple metal shafts are used for electrically connecting the light source plate and the light holder.

In some embodiments, a lighting apparatus includes a light source, a main body, a plurality of connecting sheets and a mounting frame.

The light source is installed in the main body.

An interior of the main body includes a fans assembly.

A plurality of connecting sheets are disposed at a bottom portion of the main body.

Each connecting sheet of the plurality of connecting sheets includes a first end mounted on a side wall of the main body and a second end extending in a direction away from the main body.

The mounting frame is disposed below the main body for supporting and fixing the main body.

The mounting frame includes a plurality of mounting slots.

The plurality of mounting slots are positioned to match positions of the plurality of connecting sheets.

The plurality of connecting sheets are inserted through the plurality of mounting slots of the mounting frame.

The second end of each connecting sheet of the plurality of connecting sheets is bent to achieve a snap-fit connection between the main body and the mounting frame.

In some embodiments, the first end of each connecting sheet of the plurality of connecting sheets is hingedly mounted on the side wall of the main body.

The bottom portion of the main body further includes a plurality of mounting shafts.

Each mounting shaft of the plurality of mounting shafts penetrates through both the side wall of the main body and a corresponding connecting sheet of the plurality of connecting sheets.

In some embodiments, each connecting sheet of the plurality of connecting sheets includes a separation through-slot for dividing each connecting sheet into at least two portions.

In some embodiments, the separation through-slot includes two main portions spaced apart from each other on each connecting sheet, and a connecting portion between ends of the two main portions.

The two main portions extend along a length direction of each connecting sheet.

In some embodiments, each connecting sheet of the plurality of connecting sheets further includes two bending through-slots.

The two bending through-slots are positioned on opposite sides of the separation through-slot.

In some embodiments, the separation through-slot extends along a length direction of each connecting sheet.

The separation through-slot includes an opening at one end of the separation through-slot.

In some embodiments, the mounting frame includes two parallel horizontal support plates spaced apart from each other, and a plurality of telescopic support rods disposed between the two horizontal support plates.

The plurality of mounting slots are disposed on the plurality of telescopic support rods.

In some embodiments, each horizontal support plate includes a clearance notch.

A positioning flip plate for positioning the mounting frame is disposed at the clearance notch.

In some embodiments, each telescopic support rod of the plurality of telescopic support rods includes a hollow tubular portion and a sliding portion.

The sliding portion is slidably disposed inside the hollow tubular portion.

In some embodiments, a housing of the main body includes a wiring through-hole.

A sealing cover plate is disposed at the wiring through-hole.

A first end of the sealing cover plate is snap-fitted at the wiring through-hole and a second end of the sealing cover plate is fixedly pressed against an exterior of the main body by a fastener.

In some embodiments, the fans assembly includes a first fans blade set and a second fans blade set.

The second fans blade set blows a heat dissipation air to the light source.

In some embodiments, the first fans blade set blows a main air flow outside the main body.

In some embodiments, the main air flow is larger than the heat dissipation air.

In some embodiments, the lighting apparatus may also include a switch to change wind direction of the main air flow.

In some embodiments, the switch is an IR receiver for receiving a command from a remote control.

In some embodiments, the switch toggles between a first wind direction and a second wind direction.

The first wind direction is opposite to the second wind direction.

In some embodiments, the switch is triggered when receiving a common IR signal.

In some embodiments, the common IR signal includes multiple common IR signals for controlling other electrical appliances.

In some embodiments, the first fans blade set includes a front blade and a rear blade.

The front blade is larger than the rear blade.

In some embodiments, the rear blade decreases a sound of the front blade when the front blade is rotating.

### BRIEF DESCRIPTION OF DRAWINGS

FIG. 1 illustrates an exploded view of a downlight apparatus.

FIG. 2 illustrates a side view of the downlight apparatus of FIG. 1.

FIG. 3 illustrates a top view of the downlight apparatus of FIG. 1.

FIG. 4 illustrates a cross-sectional view of the example in FIG. 1.

FIG. 5 illustrates a perspective view of the leaf spring and the light housing.

FIG. 6 illustrates a top view of the example in FIG. 5.

FIG. 7 illustrates a bottom view of the example in FIG. 5.

FIG. 8 illustrates a side view of the example in FIG. 5.

FIG. 9 illustrates a zoom-up view of a portion of the example in FIG. 5.

FIG. 10 illustrates a zoom-up view of a connection among multiple components.

FIG. 11 illustrates another bottom view of another example.

FIG. 12 illustrates a side view of another example.

FIG. 13 illustrates a wave structure pad example.

FIG. 14 illustrates another example of a light housing.

FIG. 15 illustrates a top view of the example in FIG. 14.

FIG. 16 illustrates an example of a wave structure pad.

FIG. 17 illustrates another view of the example in FIG. 16.

FIG. 18 illustrates another view of the example in FIG. 16.

FIG. 19 illustrates a combination of the shaft connector, the leaf spring and the pad.

FIG. 20 illustrates another view of the example in FIG. 19.

FIG. 21 illustrates a driver box example.

FIG. 22 illustrates another view of the example in FIG. 21.

FIG. 23 illustrates another view of the example in FIG. 21.

FIG. 24 illustrates a connector example.

FIG. 25 illustrates a component in FIG. 24.

FIG. 26 illustrates another component in FIG. 24.

FIG. 27 illustrates the connector disposed on a light source plate.

FIG. 28 illustrates an electricity distance diagram.

FIG. 29 illustrates another downlight example.

FIG. 30 illustrates the example in FIG. 29 with a wire connector.

FIG. 31 illustrates a fixing bar placed on a light housing.

FIG. 32 illustrates a heat dissipation plate placed between a driver box and a light housing.

FIG. 33 illustrates a screw for transmitting heat.

FIG. 34 illustrates a driver box example.

FIG. 35 illustrates a heat dissipation plate in an elongated form.

FIG. 36 illustrates a connector for connecting components.

FIG. 37 illustrates an exploded view of another downlight embodiment.

FIG. 38 illustrates a component in the example of FIG. 37.

FIG. 39 illustrates a bottom view of the example in FIG. 37.

FIG. 40 illustrates another example in a cross-sectional view.

FIG. 41 illustrates a zoom-up view of a connection between components.

FIG. 42 illustrates a reflective cup example.

FIG. 43 illustrates a top view of the example in FIG. 42.

FIG. 44 illustrates a side view of the example in FIG. 42.

FIG. 45 illustrates a top view of a light housing.

FIG. 46 illustrates another top view of the light housing example in FIG. 45.

FIG. 47 illustrates a cross-sectional view of the example in FIG. 46.

FIG. 48 illustrates a diffusion cover.

FIG. 49 illustrates a side view of a downlight example.

FIG. 50 illustrates a top view of the example in FIG. 49.

FIG. 51 illustrates another view of the example in FIG. 50.

FIG. 52 illustrates an exploded view of the example in FIG. 51.

FIG. 53 illustrates an elastic plate example.

FIG. 54 illustrates a connector example.

FIG. 55 illustrates another connector example.

FIG. 56 illustrates a torsion spring zoom-up view.

FIG. 57 illustrates another downlight example.

FIG. 58 illustrates a top view of the example in FIG. 57.

FIG. 59 illustrates another view of the example in FIG. 58.

FIG. 60 illustrates an exploded view of the example in FIG. 59.

FIG. 61 illustrates a connector example.

FIG. 62 illustrates a torsion spring zoom-up view.

FIG. 63 illustrates another downlight example.

FIG. 64 illustrates a top view of the example in FIG. 63.

FIG. 65 illustrates another view of the example in FIG. 64.

FIG. 66 illustrates an exploded view of the example in FIG. 65.

FIG. 67 illustrates an elastic plate example.

FIG. 68 illustrates a connector example.

FIG. 69 illustrates a side view of a diffusion cover and related components.

FIG. 70 illustrates a zoom-up view of the diffusion cover and related components.

FIG. 71 illustrates a rim part example.

FIG. 72 illustrates another view of the example in FIG. 71.

FIG. 73 illustrates a wiring unit example.

FIG. 74 illustrates an exploded view of the example in FIG. 73.

FIG. 75 illustrates a driver box with the wiring unit.

FIG. 76 illustrates a side view of the wiring unit.

FIG. 77 illustrates another view of the wiring unit.

FIG. 78 illustrates another view of the wiring unit.

FIG. 79 illustrates a fixing bracket example.

FIG. 80 illustrates another fixing bracket example.

FIG. 81 illustrates an elastic stop unit example.

FIG. 82 illustrates a top view of a downlight example with the fixing bracket.

FIG. 83 illustrates another view of the example in FIG. 82.

FIG. 84 illustrates a top view of another downlight example.

FIG. 85 illustrates another view of the example in FIG. 84.

FIG. 86 illustrates a component in the example of FIG. 85.

FIG. 87 shows another downlight example.

FIG. 88 shows a range diagram.

FIG. 89 illustrates a lighting apparatus embodiment.

FIG. 90 illustrates another view of the example in FIG. 89.

FIG. 91 illustrates a zoom-up view of an area showing a connecting sheet.

FIG. 92 illustrates another view of the example in FIG. 89.

FIG. 93 illustrates a frame used in an embodiment.

FIG. 94 illustrates a zoom-up view of a connecting structure.

FIG. 95 illustrates another lighting apparatus embodiment.

### DETAILED DESCRIPTION

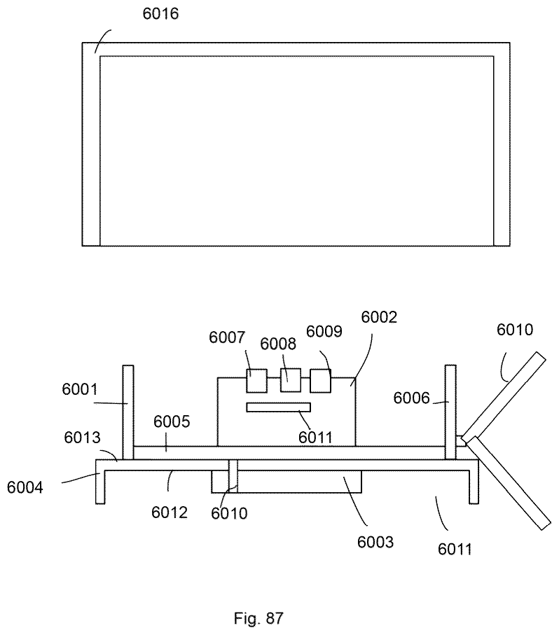

In FIG. 87, a downlight apparatus includes a light source 6003, a light holder 6004, a driver box 6002, a fixing bracket 6001 and two torsion springs 6010.

The light holder 6004 is used for placing the light source 6003. The light holder 6004 has a first side 6012 defining a light opening 6011.

The driver box 6002 is placed on a second side 6013 of the light holder 6004.

The driver box 6002 contains a driver 6011 for converting an external power to a driving current supplied to the light source 6003 to emit a light from the light opening 6011.

The fixing bracket 6001 is coupled to the light holder 6004 for fixing to an installation cavity, e.g. a cavity in a ceiling or a junction box. A junction box refers to a metal or a plastic box pre-installed in a cavity or other platform for inserting a downlight apparatus.

The fixing bracket 6001 has a bottom plate 6005 and two connector plate 6006.

The bottom plate 6005 is fixed to the second side 6013 of the light holder 6004.

The two connector plates 6006 are disposed vertically to the bottom plate 6005. Specifically, the two connector plates 6006 may be disposed with 90 or similar angle with respect to the bottom plate 6005.

Each connector plate 6006 has two side units.

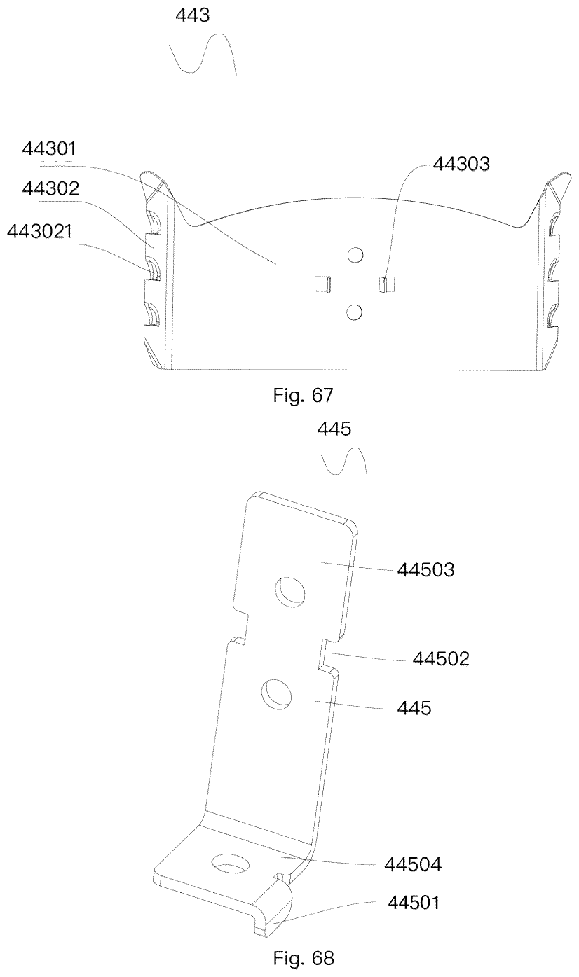

FIG. 67 shows an example of the connector plate 44301. The connector plate 44301 has two side units 440302 on two sides of the connector plate 44301.

In FIG. 87, each torsion spring 6610 has an elastic center and two arms.

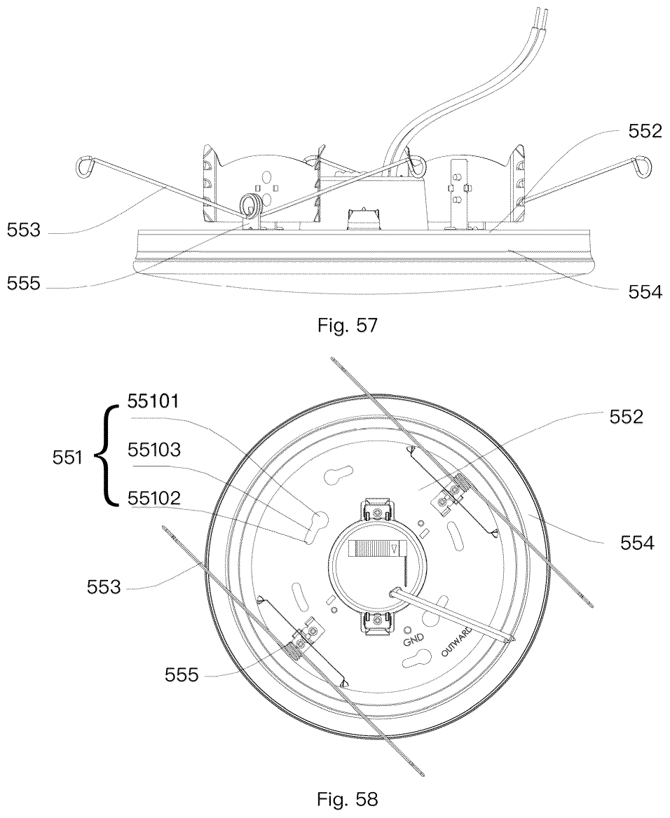

FIG. 57 shows such an example. In FIG. 57, a torsion spring has an elastic center 555 with two arms 553.

The two arms 553 are elastically spreading with different angles with respect to the elastic center 555. When an external force is applied on the two arms 553, the angle between the two arms 553 is changed, thus changing a spreading span of the two arms 553.

The spreading span is changed to insert the torsion springs into a junction box.

In FIG. 87, the two torsion springs 6610 are attached to a lateral side of the two connector plates 6006.

Either the two torsion springs are elastically squeezed to engage the installation cavity 6016 or the side units of the connector plates 6006 are elastically squeezed to engage the installation cavity.

There are several sizes of junction boxes defining different diameters of the installation cavity 6016. In some larger installation cavity, the torsion springs are used for attaching the downlight apparatus to the installation cavity. In some smaller installation cavity, the side units of the connector plates 6006 engages the installation cavity to attach the downlight apparatus to the installation cavity.

In some embodiments, the installation cavity is a cavity in a junction box.

In FIG. 66, the bottom plate of the fixing bracket has a central hole 44991 for the driver box to pass through.

In FIG. 66, the driver box or the holder plate has an elastic hook 44992.

When the central hole 44991 of the bottom plate passes reaches a bottom edge of the driver box, the elastic hook 44992 locks the bottom plate to the second side of the light holder.

In FIG. 66, the bottom plate has multiple connection holes 441 for fixing the bottom plate to the installation cavity with bracket connectors, e.g. screws.

In some embodiments, the connection hole is a key hole with an larger entrance 44101 and a smaller siding track 44102, as shown in FIG. 66.

The bracket connector enters the larger entrance and then stays in the sliding track to fix the bottom bracket to the installation cavity.

In FIG. 66, the connector plates 443 are detachable from the bottom plate 442.

In some embodiments, the connector plates are fixed to the bottom plate with screws, as shown in the exploded view in FIG. 66.

In FIG. 66, the two side units 44302 are two folded plates folding with respect to a main body 44301 of the connector plate 443.

In some embodiments, a folding angle of the folded plate with respect to the main body of the connector plate is larger than 90 degrees.

In some embodiments, the connector plates are made as the same metal piece as the bottom plate and are folded vertically with respect to the bottom plate.

In some embodiments, the fixing bracket has a scraper, e.g. a sharpen surface or a wave structure 112 in FIG. 18 for scraping a portion of electric insulation layer on the second side of the light holder for electrically connecting the light holder to ground.

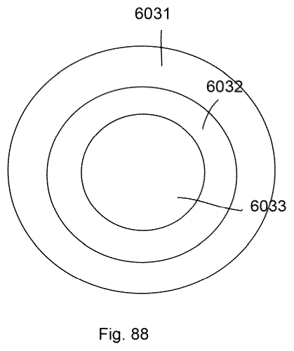

In FIG. 88, the light source includes multiple LED modules distributed in a first range 6033.

The bottom plate on the holder plate 6031 of the light holder has a larger size 6032 than the first range to carry heat of the first range outside the first range.

In FIG. 83, the bottom plate has multiple bracket connectors 962.

The second side of the light holder has corresponding multiple holder connectors 963.

The bracket connectors 962 are respectively slided to engage the holder connectors 963 by rotating the light holder with respect to to the fixing bracket.

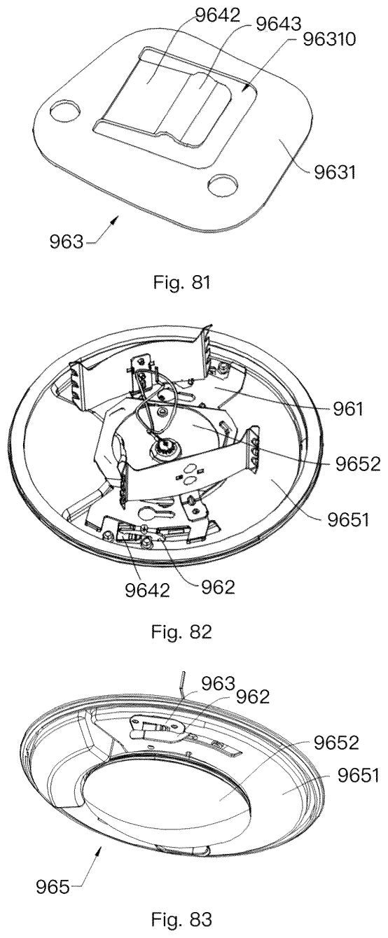

In FIG. 81, a reverse lock structure 9643 prevents the bracket connector 963 accidently escape from the holder connector 963.

In some embodiments, the bracket connector is vertical to the holder connector, as shown in FIG. 83.

In FIG. 87, a top plate of the driver box has a wire socket 6007 and a manual switch 6008.

The wire socket 6007 is connected to a power wire and the manual switch 6008 is used for adjusting a setting of the light source.

In some embodiments, the top plate of the driver box further has a rotation switch 6009 for continuously setting a maximum light intensity of the light source.

In some embodiments, the light source has a light source plate mounted with LED modules.

The light source plate is connected to the light holder to connect to the ground.

In FIG. 87, multiple metal shafts 6010 are used for electrically connecting the light source plate and the light holder.

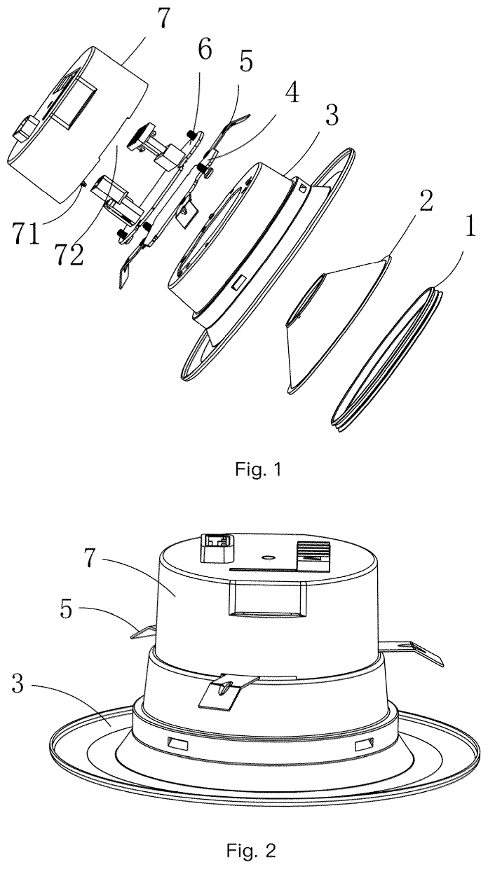

FIG. 1 illustrates an exploded view of a downlight apparatus.

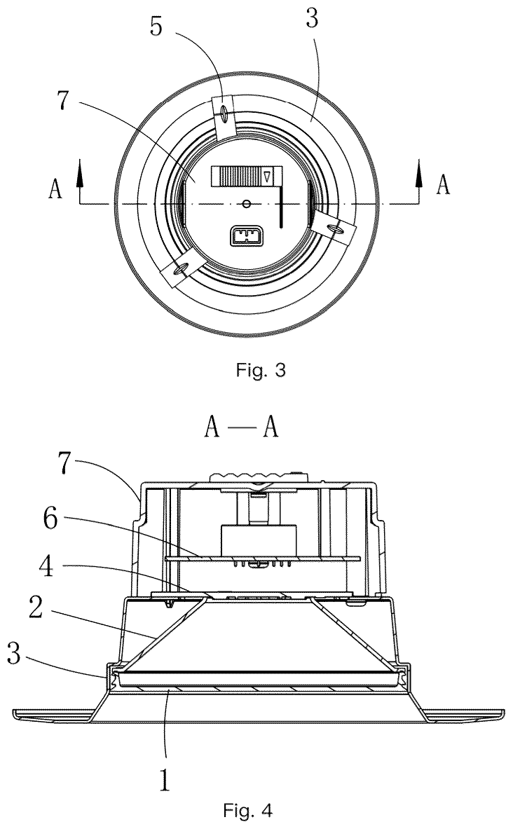

FIG. 2 illustrates a side view of the downlight apparatus of FIG. 1.

FIG. 3 illustrates a top view of the downlight apparatus of FIG. 1.

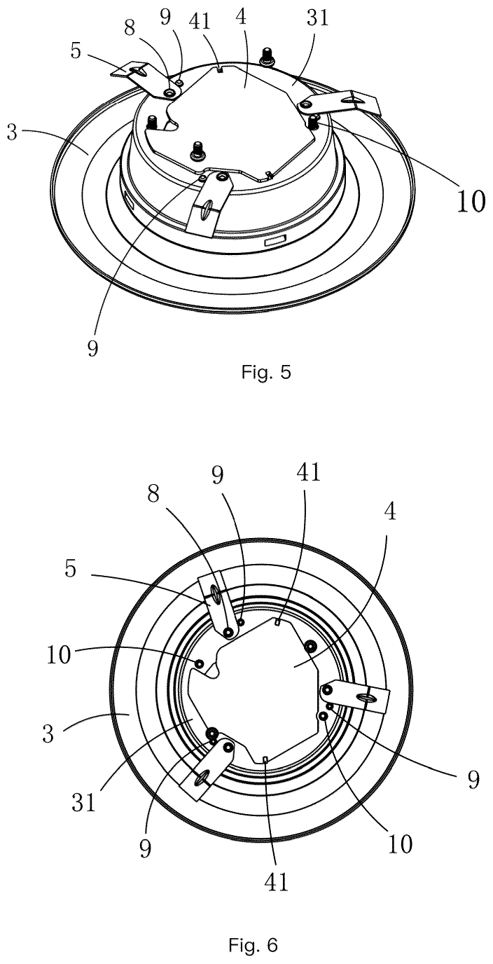

FIG. 4 illustrates a cross-sectional view of the example in FIG. 1.

FIG. 5 illustrates a perspective view of the leaf spring and the light housing.

FIG. 6 illustrates a top view of the example in FIG. 5.

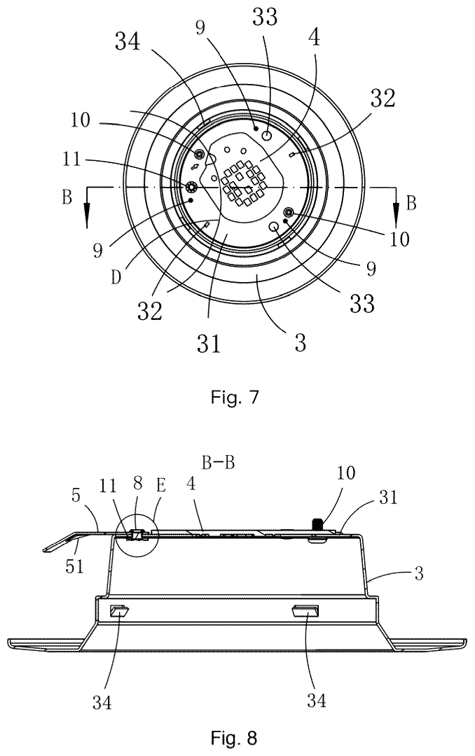

FIG. 7 illustrates a bottom view of the example in FIG. 5.

FIG. 8 illustrates a side view of the example in FIG. 5.

FIG. 9 illustrates a zoom-up view of a portion of the example in FIG. 5.

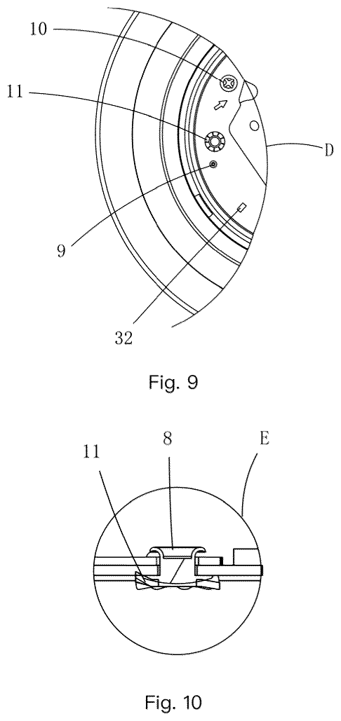

FIG. 10 illustrates a zoom-up view of a connection among multiple components.

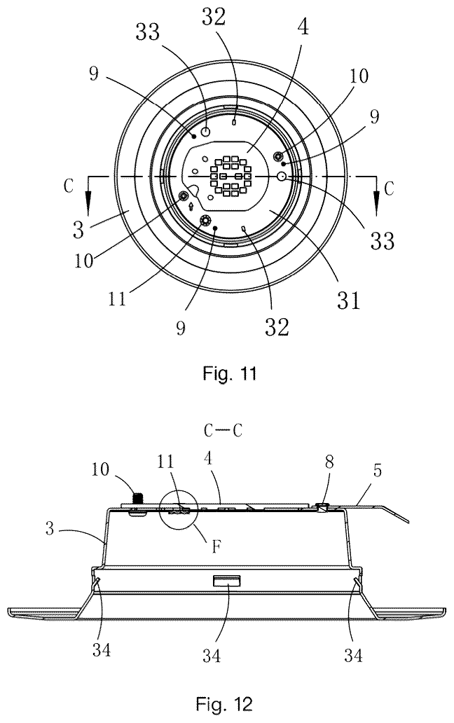

FIG. 11 illustrates another bottom view of another example.

FIG. 12 illustrates a side view of another example.

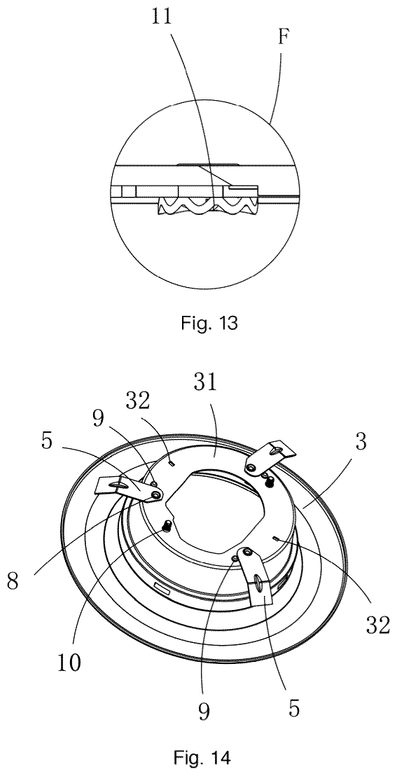

FIG. 13 illustrates a wave structure pad example.

FIG. 14 illustrates another example of a light housing.

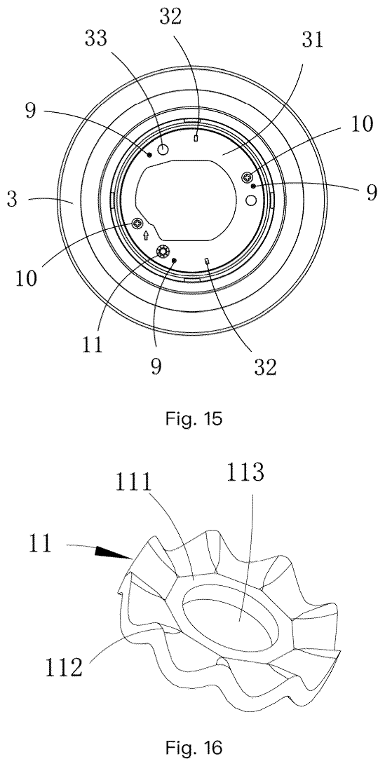

FIG. 15 illustrates a top view of the example in FIG. 14.

FIG. 16 illustrates an example of a wave structure pad.

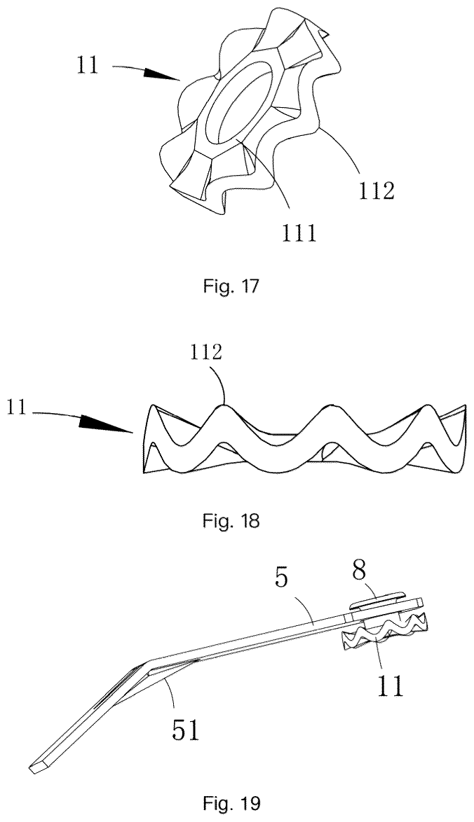

FIG. 17 illustrates another view of the example in FIG. 16.

FIG. 18 illustrates another view of the example in FIG. 16.

FIG. 19 illustrates a combination of the shaft connector, the leaf spring and the pad.

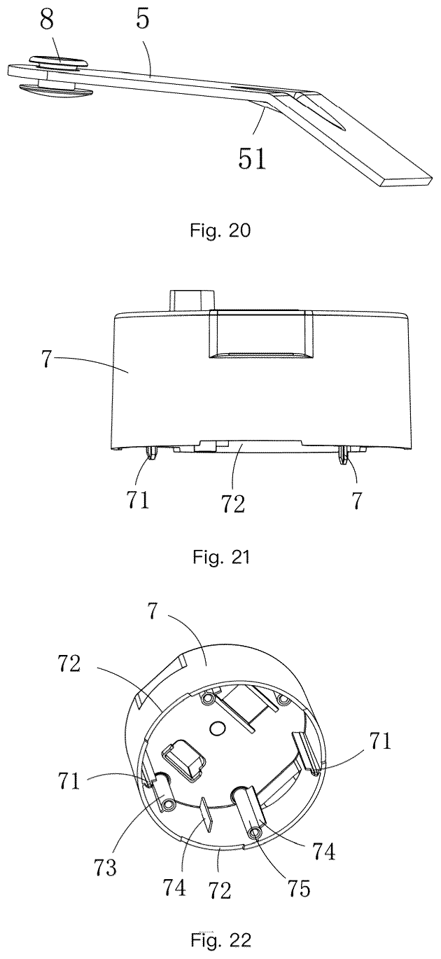

FIG. 20 illustrates another view of the example in FIG. 19.

FIG. 21 illustrates a driver box example.

FIG. 22 illustrates another view of the example in FIG. 21.

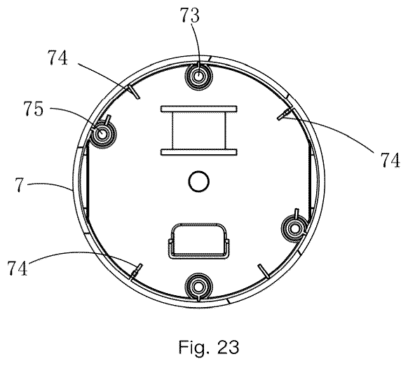

FIG. 23 illustrates another view of the example in FIG. 21.

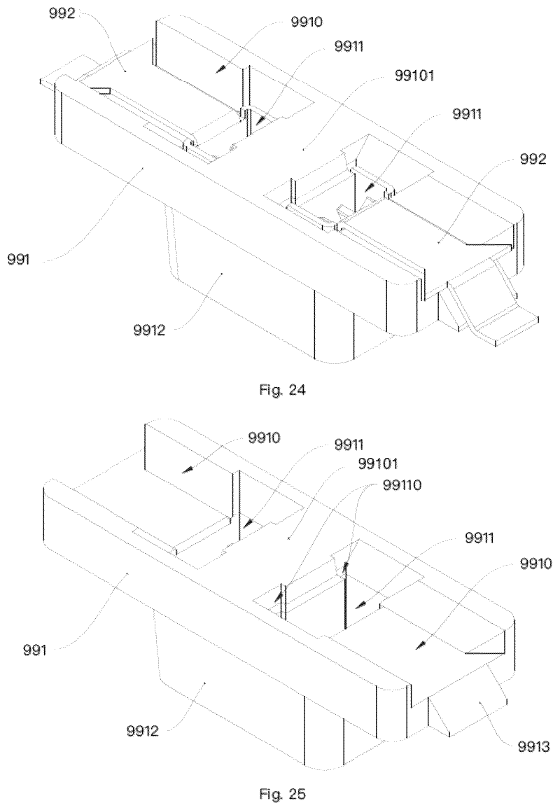

FIG. 24 illustrates a connector example.

FIG. 25 illustrates a component in FIG. 24.

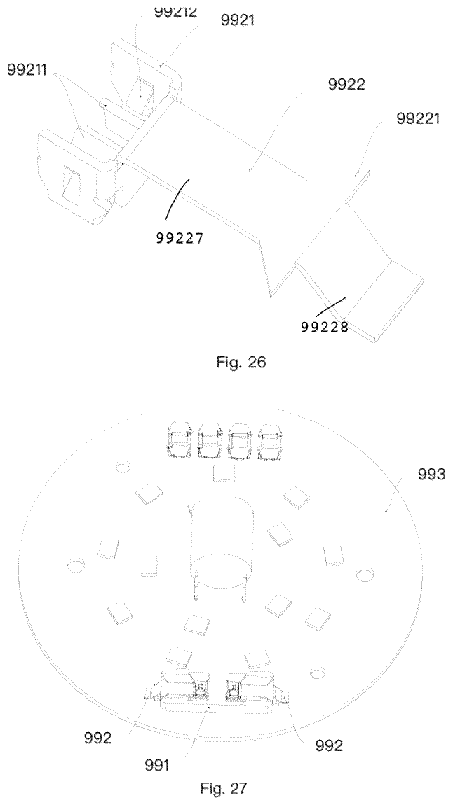

FIG. 26 illustrates another component in FIG. 24.

FIG. 27 illustrates the connector disposed on a light source plate.

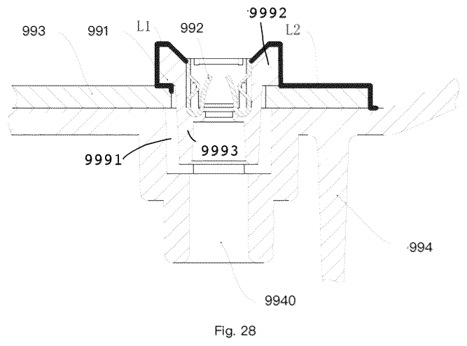

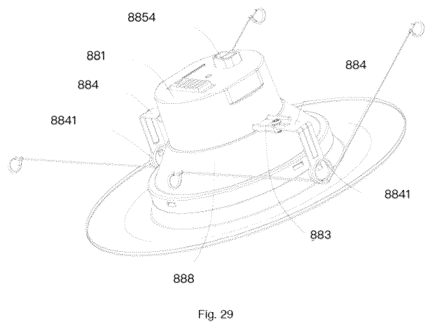

FIG. 28 illustrates an electricity distance diagram.

FIG. 29 illustrates another downlight example.

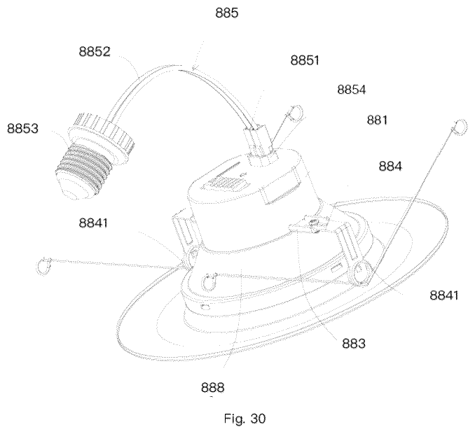

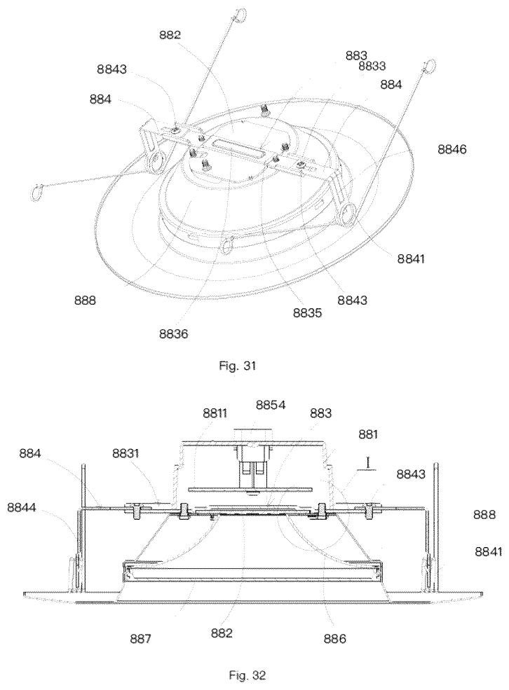

FIG. 30 illustrates the example in FIG. 29 with a wire connector.

FIG. 31 illustrates a fixing bar placed on a light housing.

FIG. 32 illustrates a heat dissipation plate placed between a driver box and a light housing.

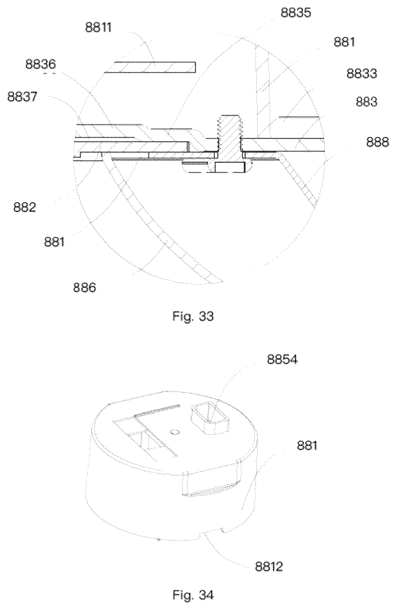

FIG. 33 illustrates a screw for transmitting heat.

FIG. 34 illustrates a driver box example.

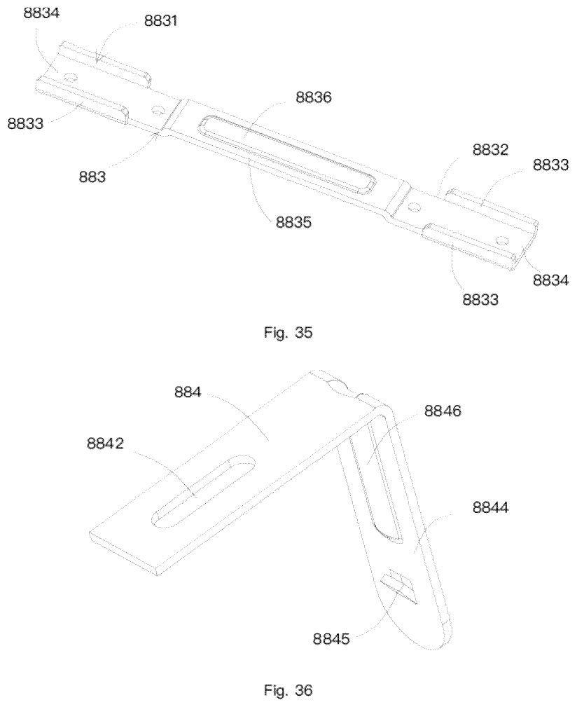

FIG. 35 illustrates a heat dissipation plate in an elongated form.

FIG. 36 illustrates a connector for connecting components.

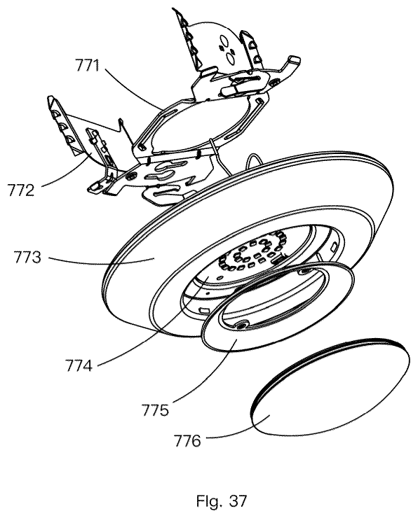

FIG. 37 illustrates an exploded view of another downlight embodiment.

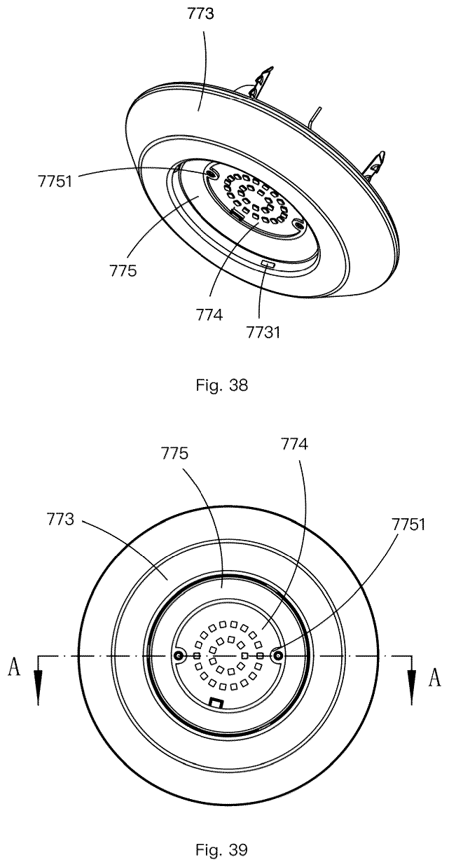

FIG. 38 illustrates a component in the example of FIG. 37.

FIG. 39 illustrates a bottom view of the example in FIG. 37.

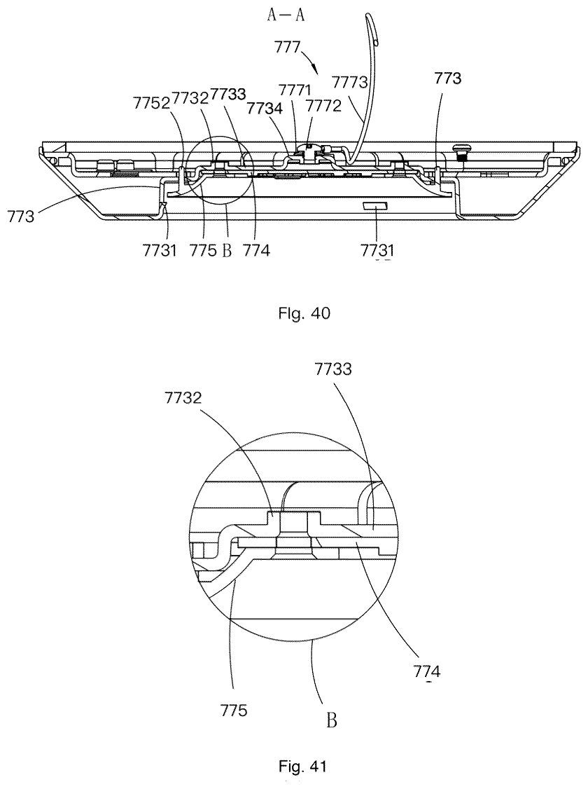

FIG. 40 illustrates another example in a cross-sectional view.

FIG. 41 illustrates a zoom-up view of a connection between components.

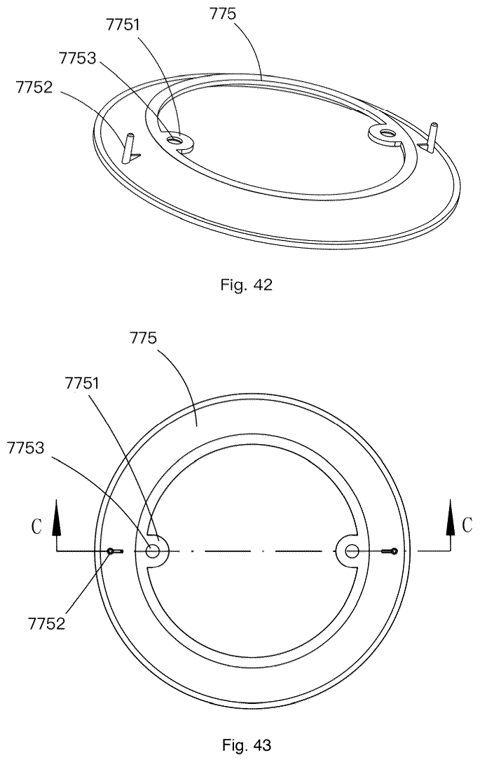

FIG. 42 illustrates a reflective cup example.

FIG. 43 illustrates a top view of the example in FIG. 42.

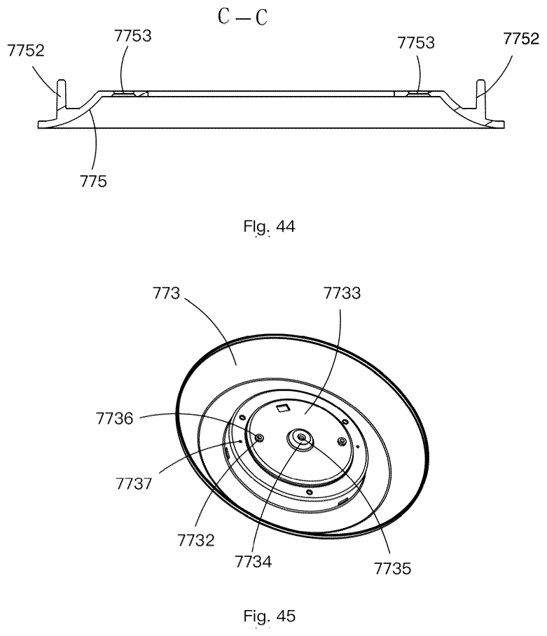

FIG. 44 illustrates a side view of the example in FIG. 42.

FIG. 45 illustrates a top view of a light housing.

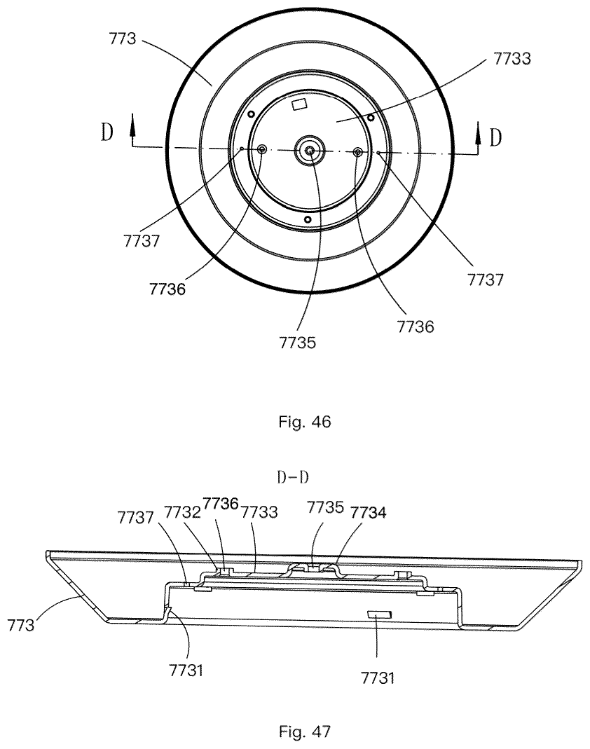

FIG. 46 illustrates another top view of the light housing example in FIG. 45.

FIG. 47 illustrates a cross-sectional view of the example in FIG. 46.

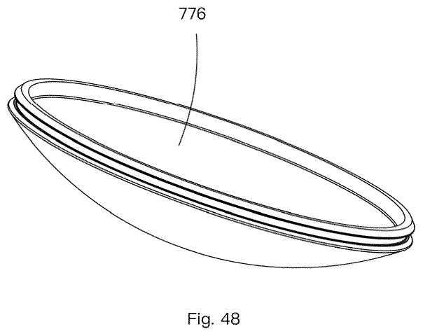

FIG. 48 illustrates a diffusion cover.

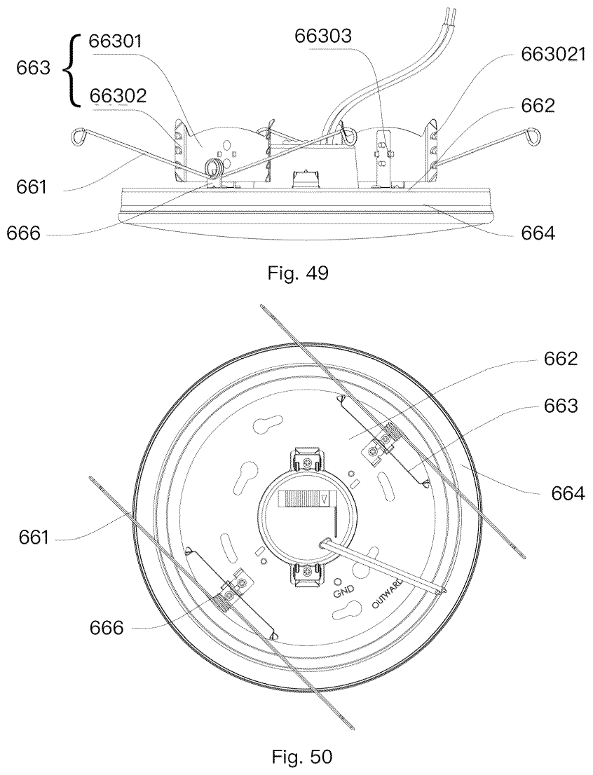

FIG. 49 illustrates a side view of a downlight example.

FIG. 50 illustrates a top view of the example in FIG. 49.

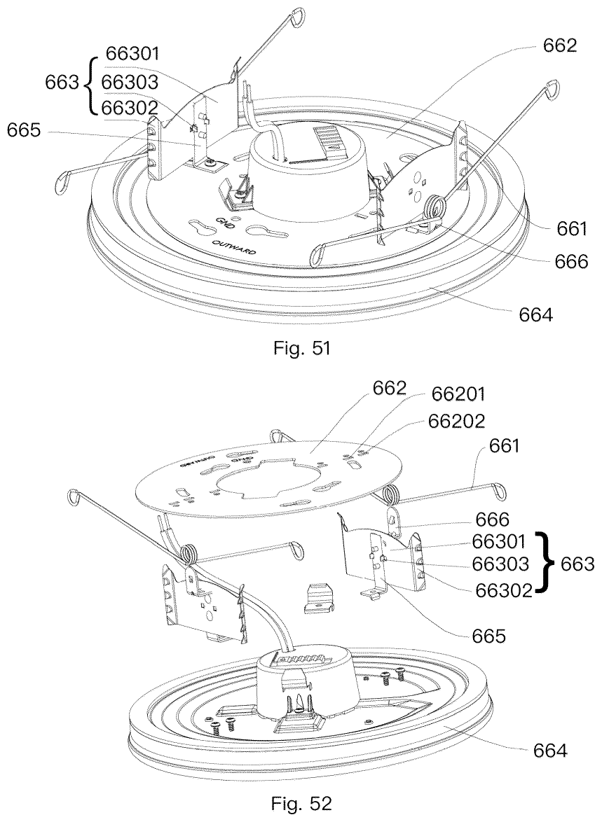

FIG. 51 illustrates another view of the example in FIG. 50.

FIG. 52 illustrates an exploded view of the example in FIG. 51.

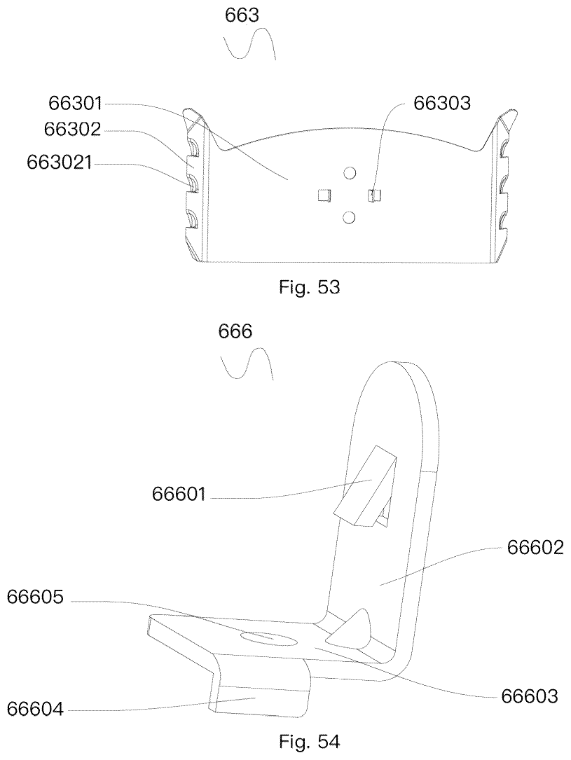

FIG. 53 illustrates an elastic plate example.

FIG. 54 illustrates a connector example.

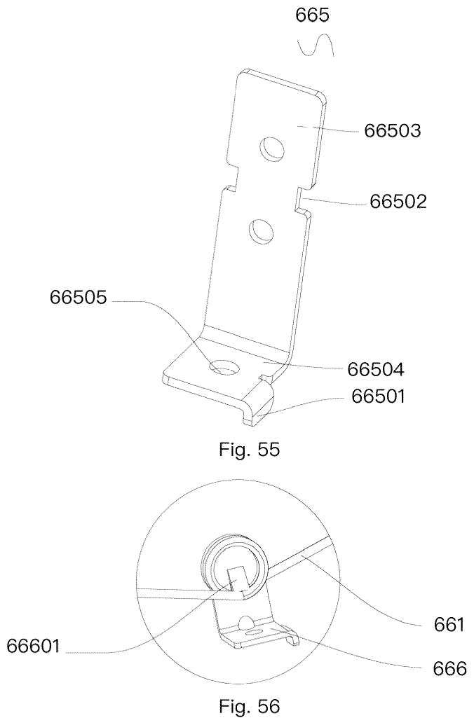

FIG. 55 illustrates another connector example.

FIG. 56 illustrates a torsion spring zoom-up view.

FIG. 57 illustrates another downlight example.

FIG. 58 illustrates a top view of the example in FIG. 57.

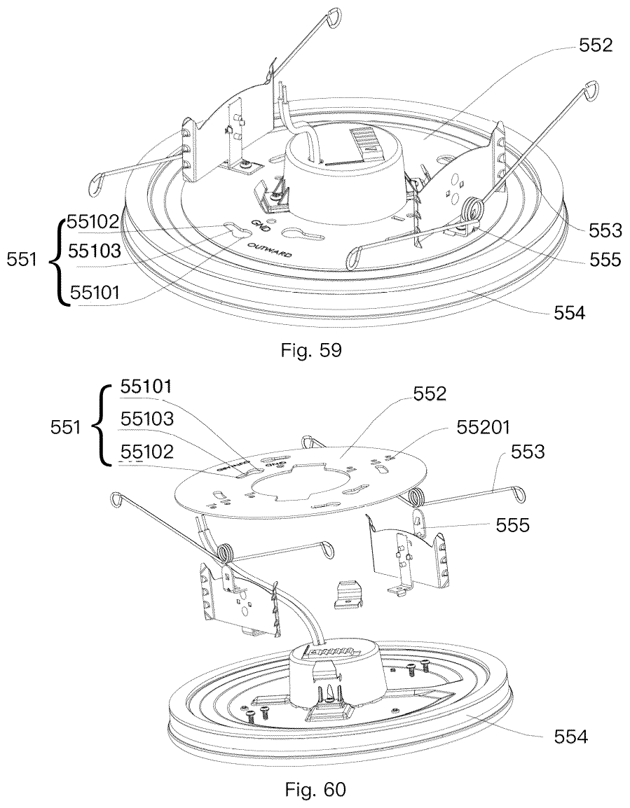

FIG. 59 illustrates another view of the example in FIG. 58.

FIG. 60 illustrates an exploded view of the example in FIG. 59.

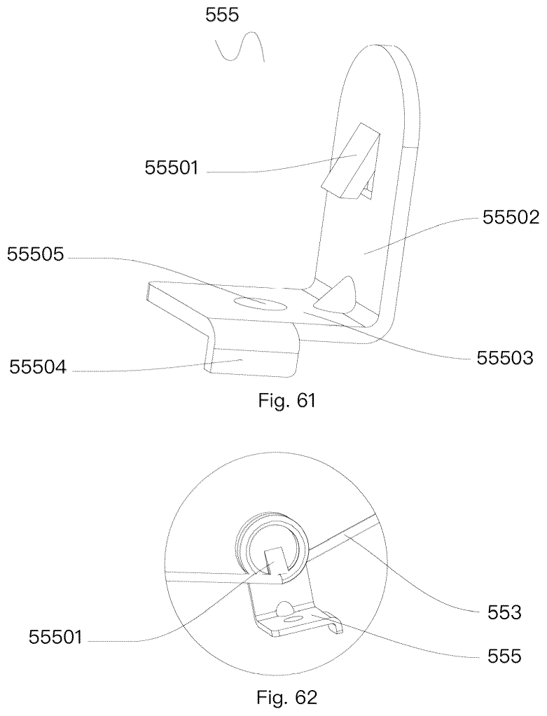

FIG. 61 illustrates a connector example.

FIG. 62 illustrates a torsion spring zoom-up view.

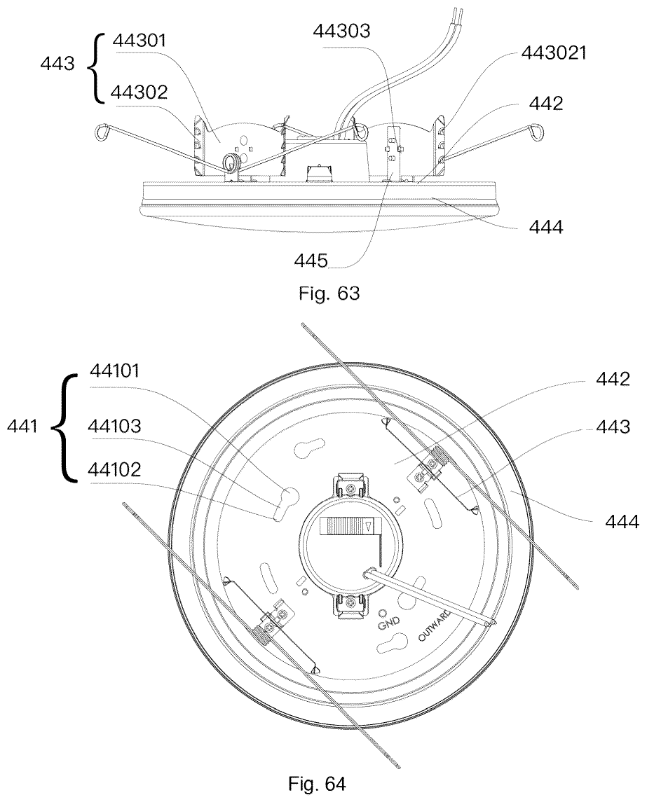

FIG. 63 illustrates another downlight example.

FIG. 64 illustrates a top view of the example in FIG. 63.

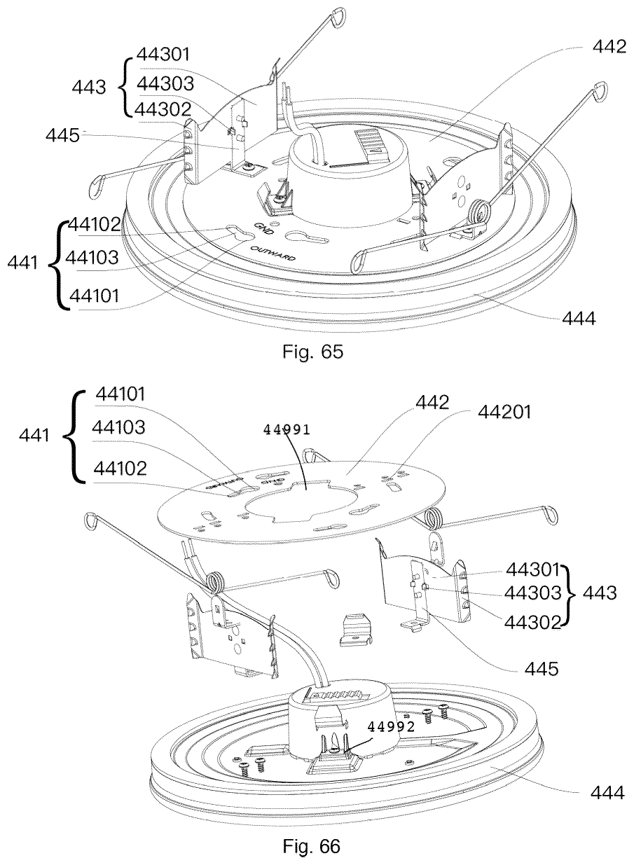

FIG. 65 illustrates another view of the example in FIG. 64.

FIG. 66 illustrates an exploded view of the example in FIG. 65.

FIG. 67 illustrates an elastic plate example.

FIG. 68 illustrates a connector example.

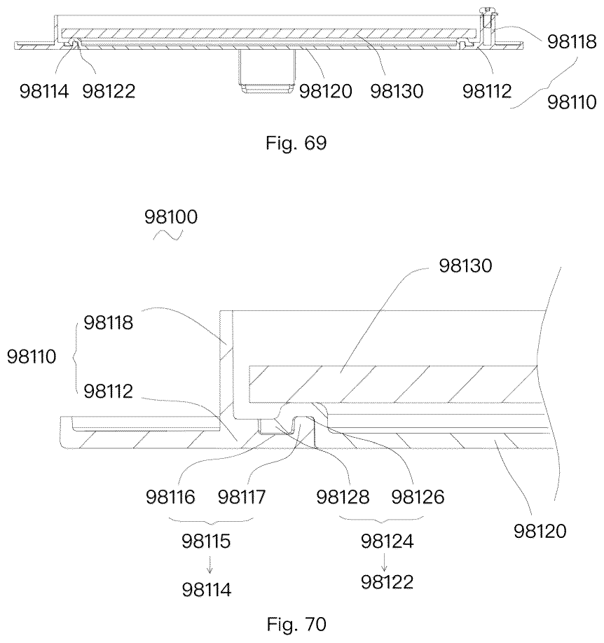

FIG. 69 illustrates a side view of a diffusion cover and related components.

FIG. 70 illustrates a zoom-up view of the diffusion cover and related components.

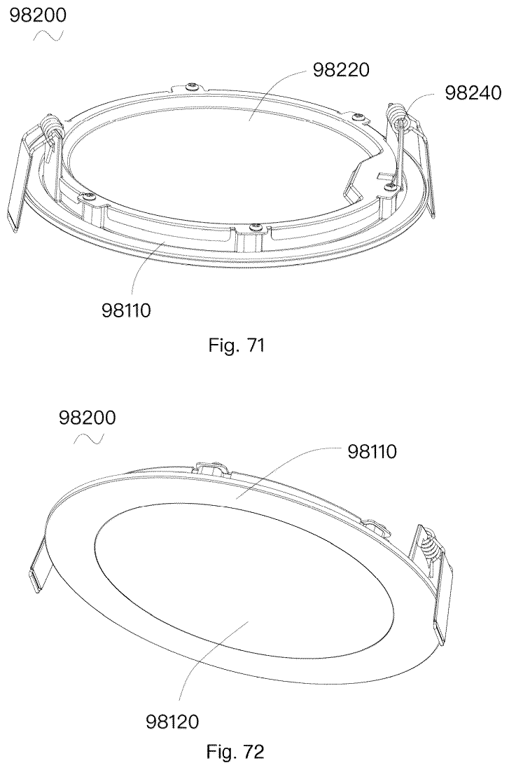

FIG. 71 illustrates a rim part example.

FIG. 72 illustrates another view of the example in FIG. 71.

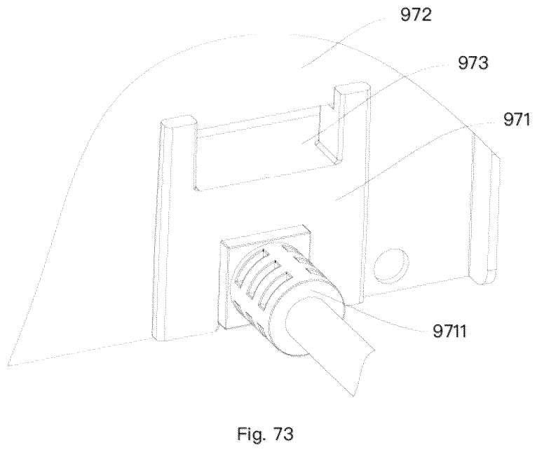

FIG. 73 illustrates a wiring unit example.

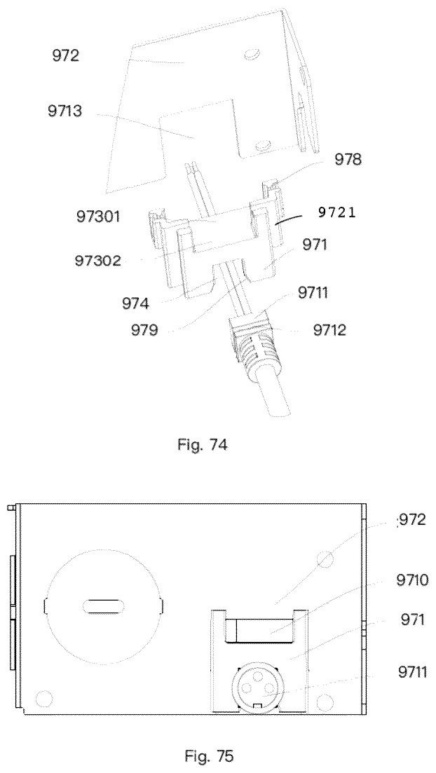

FIG. 74 illustrates an exploded view of the example in FIG. 73.

FIG. 75 illustrates a driver box with the wiring unit.

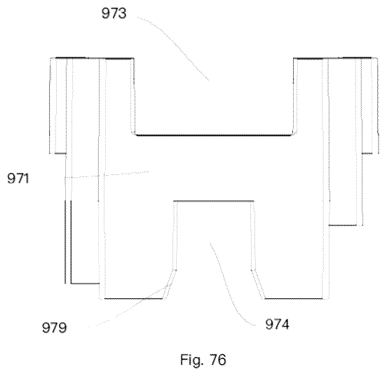

FIG. 76 illustrates a side view of the wiring unit.

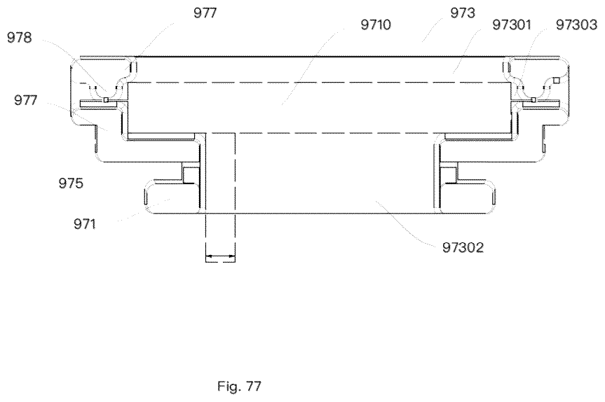

FIG. 77 illustrates another view of the wiring unit.

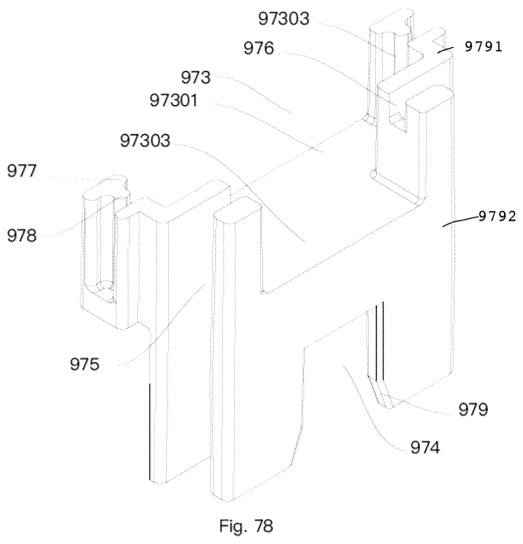

FIG. 78 illustrates another view of the wiring unit.

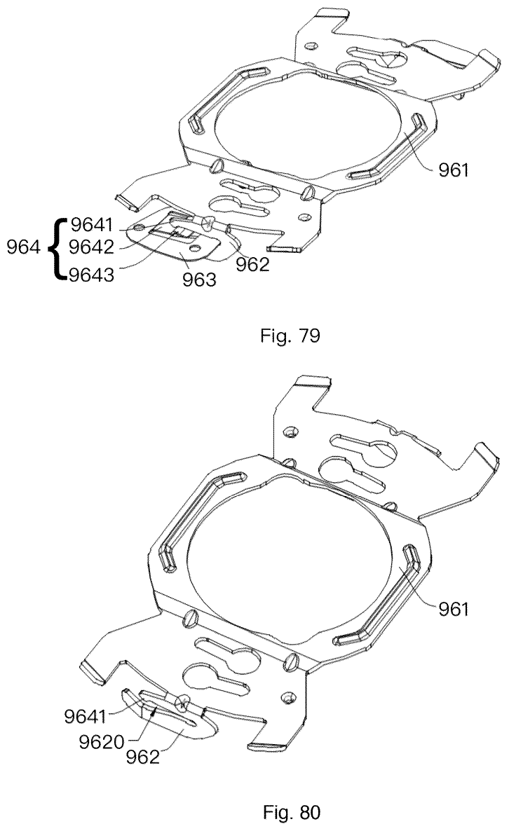

FIG. 79 illustrates a fixing bracket example.

FIG. 80 illustrates another fixing bracket example.

FIG. 81 illustrates an elastic stop unit example.

FIG. 82 illustrates a top view of a downlight example with the fixing bracket.

FIG. 83 illustrates another view of the example in FIG. 82.

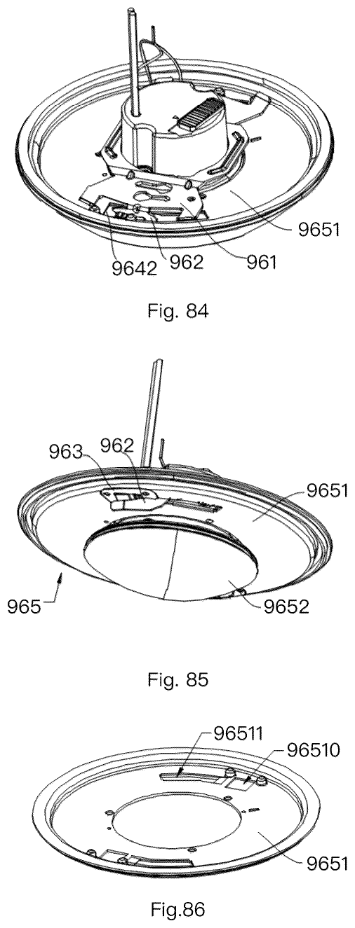

FIG. 84 illustrates a top view of another downlight example.

FIG. 85 illustrates another view of the example in FIG. 84.

FIG. 86 illustrates a component in the example of FIG. 85. In some embodiments, a lighting apparatus includes a light source, a main body, a plurality of connecting sheets and a mounting frame.

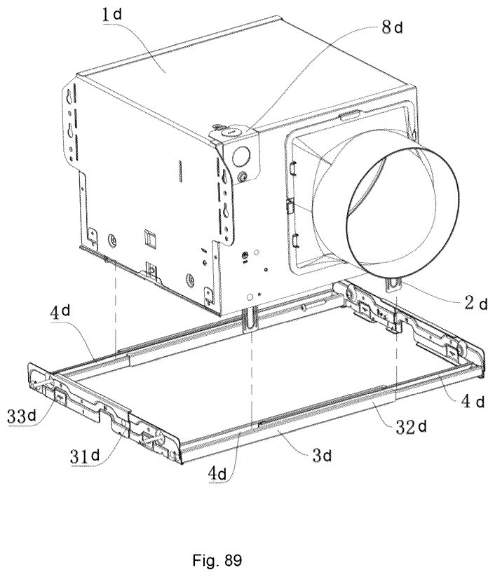

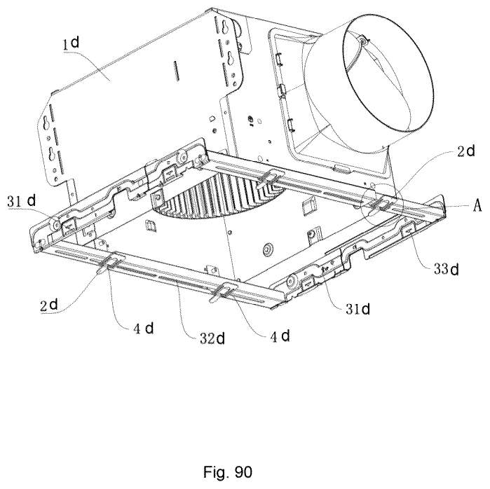

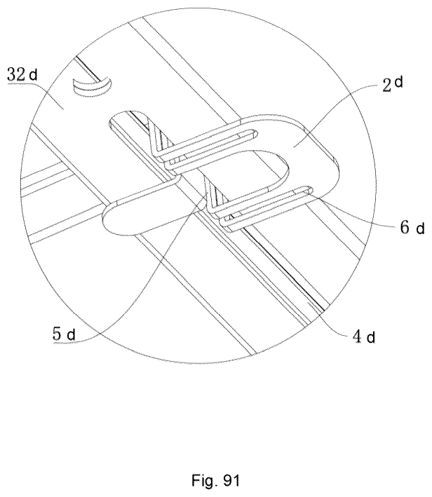

Please refer to FIG. 89 through FIG. 91, the following describes the bathroom light and fan fixing structure provided by this utility model. The bathroom light and fan fixing structure comprises a main body 1d, connecting sheets, and a mounting frame 3d. A fans assembly is disposed inside the main body 1d; multiple connecting sheets d are located at the bottom of the main body 1d, with their first ends mounted on the side wall of the main body 1d and second ends extending in a direction away from the main body 1d; the mounting frame 3d is located below the main body 1d for supporting and fixing the main body 1d, and the mounting frame 3d is also provided with multiple mounting slots 4d, wherein the mounting slots 4d match the positions of the connecting sheets 2d; the connecting sheets 2d are inserted into the mounting slots 4d and extend through the mounting frame 3d, achieving the mounting of the main body 1d to the mounting frame 3d by bending the second ends of the connecting sheets 2d.

Compared with the prior art, the bathroom light and fan fixing structure provided in this embodiment has multiple connecting sheets 2d set at the bottom of the main body 1d, with their first ends mounted on the side wall of the main body 1d and second ends extending in a direction away from the main body 1d. After the mounting frame 3d is fixed to the beam or ceiling, the connecting sheets 2d can be inserted into the mounting slots 4d provided on the mounting frame 3d. The connecting sheets 2d are inserted into the mounting slots 4d and extend through the mounting frame 3d, achieving the mounting of the main body 1d to the mounting frame 3d by bending the second ends of the connecting sheets 2d. This utility model's bathroom light and fan fixing structure, by setting the connecting sheets 2d at the bottom of the main body 1d, only requires inserting the connecting sheets 2d into the mounting slots 4d on the mounting frame 3d and bending the second ends of the connecting sheets 2d to achieve the installation and fixing of the main body 1d, reducing the assembly steps of the light and fan unit and making the installation of the main body 1d more quick and convenient, thereby improving installation efficiency.

It should be noted that after the main body 1d is interconnected and fixed with the mounting frame 3d through the connecting sheets 2d, a lighting unit needs to be installed below the mounting frame 3d. The lighting unit is typically covered at the opening in the ceiling and is mounted to the inner wall of the main body 1d through spring clips to complete the final installation.

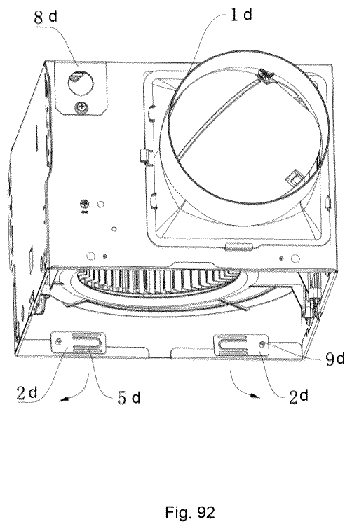

In some possible implementations, as shown in FIG. 91 and FIG. 92, the first end of the connecting sheet 2d is pivotally mounted on the side wall of the main body 1d, and multiple mounting shafts 9d are also provided at the bottom of the main body 1d, with the mounting shafts 9d extending through both the side wall of the main body 1d and the connecting sheets 2d. Specifically, the connecting sheets 2d can rotate around the axis of the mounting shafts 9d. This installation method of the connecting sheets 2d, on one hand, connects the main body 1d with the connecting sheets 2d, preventing the loss of connecting sheets 2d which would affect the installation efficiency of the light and fan unit. On the other hand, when the main body 1d is not installed, the connecting sheets 2d can be rotated to the inside of the main body 1d, thereby reducing the space volume occupied by the connecting sheets 2d and the main body 1d together, facilitating the overall packaging and placement of the main body 1d.

Preferably, one end of the mounting shaft 9d is fixed to the side wall of the main body 1d by riveting, and the other end of the mounting shaft 9d passes through the connecting sheet 2d. A pressing cap is disposed at the other end of the mounting shaft 9d. The connecting sheet 2d can be pressed and fixed to the inner wall of the main body 1d through the pressing cap, making the installation more secure. To make the connecting sheet 2d more firmly fixed in the mounting slot 4d, as shown in FIG. 91 and FIG. 92, the connecting sheet 2d is provided with a separation through-slot 5d for dividing the connecting sheet 2d into at least two parts. By dividing the connecting sheet 2d into at least two parts through the separation through-slot 5d, multiple parts of the connecting sheet 2d can be bent toward both sides of the mounting slot 4d, which can increase the strength at the second end of the connecting sheet 2d, making the connecting sheet 2d more firmly fixed in the mounting slot 4d and its installation more stable.

The above-mentioned separation through-slot 5d can adopt the structure shown in FIG. 91. Referring to FIG. 91, the separation through-slot 5d includes two main bodies 1d spaced apart from each other on the connecting sheet 2d, and a connecting portion set between the ends of the two main bodies 1d, with both main bodies 1d arranged along the length direction of the connecting sheet 2d. Specifically, the separation through-slot 5d is U-shaped as a whole, dividing the connecting sheet 2d into a larger main sheet and a smaller sheet inside the main sheet through the separation through-slot 5d. The main sheet and the smaller sheet can be bent toward both sides of the mounting slot 4d, which can increase the strength at the second end of the connecting sheet 2d, making the installation of the connecting sheet 2d more stable.

Preferably, as shown in FIG. 91, the connecting sheet 2d is also provided with two bending through-slots 6d, with these two bending through-slots 6d located on both sides of the separation through-slot 5d. Specifically, the arrangement of the bending through-slots 6d can reduce the width of the connecting sheet 2d, making it more convenient to bend the connecting sheet 2d, thus making the mounting more convenient.

As a modified implementation of the above-mentioned separation through-slot 5d, the separation through-slot 5d is arranged along the length direction of the connecting sheet 2d, with an opening set at one end of the separation through-slot 5d. Specifically, the separation through-slot 5d is a straight line, dividing the connecting sheet 2d into two parallel sheet bodies through the separation through-slot 5d. After the connecting sheet 2d is installed inside the mounting slot 4d, multiple parts of the connecting sheet 2d can be bent respectively toward both sides of the mounting slot 4d, which can increase the strength at the second end of the connecting sheet 2d and make its installation more stable.

Preferably, as another mounting method for the above-mentioned connecting sheet 2d, a rotation shaft is provided at the end of the connecting sheet 2d, and a mounting tube is provided on the inner or outer wall of the main body. The rotation shaft is rotatably mounted inside the mounting tube. The width of the connecting sheet 2d is greater than the width dimension of the mounting slot 4d. When installing the connecting sheet 2d, it can be rotated to a position parallel to the mounting slot 4d, then inserted into the mounting slot 4d, and finally rotated to make the connecting sheet 2d mounted on the other side of the mounting frame 3d, thereby achieving the connection between the main body 1d and the mounting frame 3d.

Moreover, to ensure a more secure installation, the rotation shaft protrudes beyond the mounting tube at its end away from the connecting sheet 2d, and a spring is fitted over the rotation shaft. One end of the spring is fixed to the end of the rotation shaft away from the connecting sheet 2d, while the other end abuts against the end of the mounting tube, which can push the rotation shaft to move in a direction away from the mounting tube. This ensures that the connecting sheet 2d can always abut against the side of the mounting frame 3d, ensuring the firm fixation of the main body. Additionally, a limiting groove is provided on the bottom surface of the mounting frame 3d, arranged at an angle to the mounting slot 4d, which can lock the connecting sheet 2d after rotation, preventing the connecting sheet 2d from rotating in the opposite direction and coming out of the mounting slot 4d.

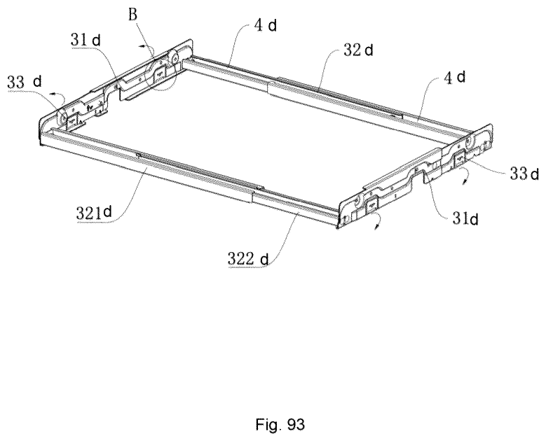

In some possible implementations, as shown in FIG. 89 and FIG. 93, the mounting frame 3d includes two parallel horizontally spaced horizontal support plates 31d and telescopic support rods 32d disposed between the two horizontal support plates 31d, with mounting slots 4d respectively disposed on the two telescopic support rods 32d. Specifically, the mounting slots 4d are disposed along the length direction of the telescopic support rods 32d. Specifically, the two horizontal support plates 31d and two telescopic support rods 32d form a rectangular frame, and the length of the telescopic support rods 32d can be adjusted to adapt the mounting frame 3d to different beam widths, making the installation of the entire mounting frame 3d more convenient and flexible.

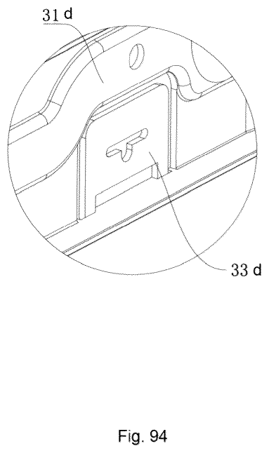

To make the positioning and installation of the mounting frame 3d more convenient, as shown in FIG. 93 and FIG. 94, the horizontal support plate 31d is provided with a clearance notch, and a positioning flip plate 33d is disposed at the clearance notch for positioning the mounting frame 3d. Specifically, before installation, the positioning flip plate 33d can be set parallel to the horizontal support plate 31d, and when the mounting frame 3d needs to be fixed, the positioning flip plate 33d can be bent and flipped 90° to position the mounting frame 3d in the height direction, making the installation position of the mounting frame 3d more precise. Preferably, the positioning flip plate 33d and the horizontal support plate 31d are integrally formed, with the positioning flip plate 33d formed by stamping a U-shaped notch on the horizontal support plate 31d, and an installation platform is provided at the bottom of the clearance notch, making the positioning flip plate 33d more secure.

Based on the above features of the mounting frame 3d, as shown in FIG. 93, each telescopic support rod 32d includes a hollow tubular portion 321d and a sliding portion 322d slidably disposed at one end within the tubular portion 321d. Specifically, the overall length of the telescopic support rod 32d can be adjusted through the sliding of the tubular portion 321d and the sliding portion 322d, and mounting slots 4d are provided on both the tubular portion 321d and sliding portion 322d. Preferably, the cross-sections of both the tubular portion 321d and sliding portion 322d are rectangular or polygonal, preventing relative rotation between the sliding portion 322d and tubular portion 321d during sliding.

Preferably, a relief groove is provided on the top surface of the tubular portion 321d along its length direction, and a relief groove is also provided on the top surface of the sliding portion 322d along its length direction, where the top surface is referenced based on the mounted position of the mounting frame 3d. Two upward protruding portions are provided at the end of the sliding portion 322d away from the horizontal support plate 31d, and after the sliding portion 322d is installed inside the tubular portion 321d, the sides of the two protruding portions abut against the sidewalls of the relief groove on the top surface of the tubular portion 321d. A limiting portion is also provided at the end of the tubular portion 321d away from the horizontal support plate 31d, located on the inner wall of the relief groove and extending in a direction parallel to the top surface of the tubular portion 321d. This way, after the sliding portion 322d is installed inside the tubular portion 321d, the cooperation between the protruding portions and limiting portion prevents the sliding portion 322d from detaching from the tubular portion 321d during sliding, making the mounting frame 3d more convenient to use.

In some possible implementations, as shown in FIG. 89 and FIG. 92, a wiring through-hole 7d is provided on the housing of the main body 1d, and a sealing cover plate 8d is provided at the wiring hole, with one end of the sealing cover plate 8d mounted at the wiring through-hole 7d and the other end fixed by pressure to the exterior of the main body 1d using fasteners. Specifically, when the main body 1d needs to be connected to circuits, the sealing cover plate 8d can be removed from the wiring through-hole 7d, making it more convenient to connect the circuits to electrical components inside the main body 1d. Meanwhile, the sealing cover plate 8d can maintain internal sealing when the main body 1d is not installed.

Preferably, the wiring through-hole 7d is provided at the top of the main body 1d, specifically at the intersection of the side and top surfaces, and correspondingly, the sealing cover plate 8d has an overall L-shape, making wiring more convenient.

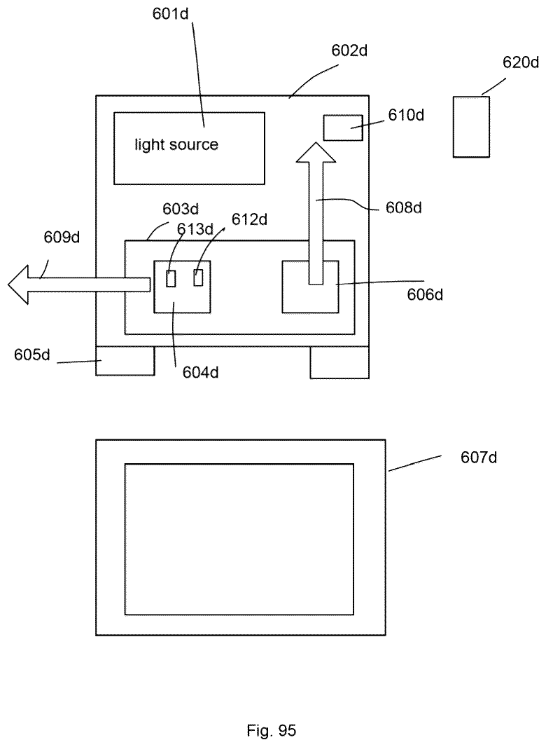

Please refer to FIG. 95, a light source 601d is installed in the main body 602d. An interior of the main body includes a fans assembly 603d.

A plurality of connecting sheets 605d are disposed at a bottom portion of the main body 602d.

Each connecting sheet 605d of the plurality of connecting sheets includes a first end mounted on a side wall of the main body 602d and a second end extending in a direction away from the main body 602d.

The mounting frame 607d is disposed below the main body 602d for supporting and fixing the main body 602d.

The mounting frame 607d includes a plurality of mounting slots.

The plurality of mounting slots are positioned to match positions of the plurality of connecting sheets.

The plurality of connecting sheets 605d are inserted through the plurality of mounting slots of the mounting frame 607d.

The second end of each connecting sheet of the plurality of connecting sheets is bent to achieve a snap-fit connection between the main body and the mounting frame.

In some embodiments, the first end of each connecting sheet of the plurality of connecting sheets is hingedly mounted on the side wall of the main body.

The bottom portion of the main body further includes a plurality of mounting shafts.

Each mounting shaft of the plurality of mounting shafts penetrates through both the side wall of the main body and a corresponding connecting sheet of the plurality of connecting sheets.

In some embodiments, each connecting sheet of the plurality of connecting sheets includes a separation through-slot for dividing each connecting sheet into at least two portions.

In some embodiments, the separation through-slot includes two main portions spaced apart from each other on each connecting sheet, and a connecting portion between ends of the two main portions.

The two main portions extend along a length direction of each connecting sheet.

In some embodiments, each connecting sheet of the plurality of connecting sheets further includes two bending through-slots.

The two bending through-slots are positioned on opposite sides of the separation through-slot.

In some embodiments, the separation through-slot extends along a length direction of each connecting sheet.

The separation through-slot includes an opening at one end of the separation through-slot.

In some embodiments, the mounting frame includes two parallel horizontal support plates spaced apart from each other, and a plurality of telescopic support rods disposed between the two horizontal support plates.

The plurality of mounting slots are disposed on the plurality of telescopic support rods.

In some embodiments, each horizontal support plate includes a clearance notch.

A positioning flip plate for positioning the mounting frame is disposed at the clearance notch.

In some embodiments, each telescopic support rod of the plurality of telescopic support rods includes a hollow tubular portion and a sliding portion.

The sliding portion is slidably disposed inside the hollow tubular portion.

In some embodiments, a housing of the main body includes a wiring through-hole.

A sealing cover plate is disposed at the wiring through-hole.

A first end of the sealing cover plate is snap-fitted at the wiring through-hole and a second end of the sealing cover plate is fixedly pressed against an exterior of the main body by a fastener.

In some embodiments, the fans assembly 603d includes a first fans blade set 604d and a second fans blade set 606d.

The second fans blade set 606d blows a heat dissipation air 608d to the light source 601d.

In some embodiments, the first fans blade set 604d blows a main air flow 609d outside the main body 602d.

In some embodiments, the main air flow 609d is larger than the heat dissipation air 608d.

In some embodiments, the lighting apparatus may also include a switch 610d to change wind direction of the main air flow.

In some embodiments, the switch 610d is an IR receiver for receiving a command from a remote control 620d.

In some embodiments, the switch 610d toggles between a first wind direction and a second wind direction.

In some embodiments, the switch 610d contains an infrared (IR) receiver that has been designed to interpret any commonly used IR command, making it highly versatile and compatible with a wide range of household remote controls. This IR receiver doesn't discriminate between device-specific commands; it can recognize and respond to signals intended for various appliances such as TVs, sound systems, and air conditioners. By interpreting common commands like “TV power on,” “volume up,” or “AC temperature control,” the IR receiver provides a seamless way for users to interact with the fan's switch 610d without needing a specialized remote, simplifying the overall experience and reducing clutter in the home.

When the IR receiver detects any of these known IR commands, the switch 610d simply toggles the wind direction of the fan, switching between a first wind direction and a second. This straightforward approach eliminates the need for complex programming or multiple button presses. Instead, a single command, regardless of the intended device, activates the fan's directional toggle. For users, this design enhances convenience, as they can use nearly any available remote control to control the fan's airflow direction. This feature is particularly useful in multi-device households, as it allows for greater flexibility without requiring a designated remote.

The ability to toggle between two fixed wind directions adds to the system's simplicity and functionality. Since only two directions are available, users can easily switch between them with just one press of any common IR button, creating a more intuitive user experience. For instance, if the fan is set to direct airflow upward initially, pressing any button on the remote will change it to a downward flow, and pressing it again will revert it. This two-option toggle system is efficient, reducing the risk of confusion and allowing users to easily control airflow with minimal interaction.

Additionally, the use of an IR receiver that is responsive to various commands makes this setup adaptable to existing smart home configurations. Users who have programmed IR universal remotes or integrated devices into a smart home system can incorporate the fan into their routines effortlessly. For example, a universal remote or voice-activated system programmed to send common IR signals can also manage the fan's wind direction. This compatibility with existing systems and technologies further enhances the fan's usability, enabling it to blend seamlessly into diverse home environments without additional setup.

The fan's adaptability to various IR commands offers a cost-effective solution to users who do not need to invest in a separate control system. Because it works with any standard remote, it minimizes the need for specialized hardware, benefiting users who prefer to minimize device clutter and reduce costs. This setup appeals to those looking for simplicity and affordability, making it an excellent choice for a wide range of users who value practicality. This design, integrating ease of control with cost-saving and space-saving features, positions the fan as a user-friendly and efficient option for any household.

The first wind direction is opposite to the second wind direction.

In some embodiments, the switch is triggered when receiving a common IR signal.

In some embodiments, the common IR signal includes multiple common IR signals for controlling other electrical appliances.

In some embodiments, the first fans blade set includes a front blade 613d and a rear blade 612d.

The front blade 613d is larger than the rear blade 612d.

In some embodiments, the rear blade 612d decreases a sound of the front blade 613d when the front blade is rotating.

In some embodiments, two fans are utilized to enhance efficiency and reduce noise levels. This dual-fan configuration leverages the front and rear fan blade sets, each strategically designed to optimize airflow while minimizing the turbulence that typically generates unwanted noise. The front blade 613d, designed with a larger surface area, captures and channels air in a more controlled manner. This setup allows the rear blade 612d to focus on stabilizing the airflow further, effectively reducing the acoustic footprint created by the rapid rotation of the front blade.

The distinct sizes of the front and rear blades are critical to this noise-reduction mechanism. With the front blade being larger than the rear, it maximizes the initial air intake, while the rear blade operates in tandem, working to balance and quiet the flow of air. This contrast in blade dimensions helps prevent the collision of turbulent air currents between the blades, which is a primary cause of noise in conventional fan setups. By staggering the blade sizes, the fan achieves a smoother overall airflow, contributing to quieter operation.

Another key feature in these embodiments is the aerodynamic design of the rear blade. The rear blade 612d is engineered to act as a sound-dampening agent for the fan system. Positioned to rotate just behind the larger front blade, the rear blade intercepts and dampens the noise waves generated by the front blade's movement. This design reduces the sound of the fan when in use, offering a quieter user experience without sacrificing performance. The rear blade's role as a noise diffuser is especially useful in applications where fans operate continuously and low noise levels are essential.

In addition to noise reduction, this dual-blade system enhances the overall efficiency of the fan by improving air circulation. With each blade contributing differently to the airflow, the fan can move more air without needing to increase the speed of rotation drastically, thus reducing power consumption and mechanical stress. The configuration allows the fan to maintain a stable and powerful air output, with the rear blade smoothing out the airflow patterns generated by the larger front blade. This arrangement is particularly advantageous in settings where energy efficiency and performance longevity are priorities.

The system's ability to process a common infrared (IR) signal for operation enhances its versatility. The fan can receive multiple IR signals commonly used to control other appliances, making it compatible with a range of remote-controlled systems. This integration adds convenience for users who can manage the fan and other devices with a single remote. The combined benefits of noise reduction, enhanced efficiency, and streamlined control make this fan design an ideal choice for applications demanding quiet, energy-efficient operation.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a light source;
a main body, wherein the light source is installed in the main body, wherein an interior of the main body comprises a fans assembly;
a plurality of connecting sheets disposed at a bottom portion of the main body, wherein each connecting sheet of the plurality of connecting sheets comprises a first end mounted on a side wall of the main body and a second end extending in a direction away from the main body;
a mounting frame disposed below the main body for supporting and fixing the main body, wherein the mounting frame comprises a plurality of mounting slots, wherein the plurality of mounting slots are positioned to match positions of the plurality of connecting sheets, wherein the plurality of connecting sheets are inserted through the plurality of mounting slots of the mounting frame, wherein the second end of each connecting sheet of the plurality of connecting sheets is bent to achieve a snap-fit connection between the main body and the mounting frame.

2. The lighting apparatus of claim 1, wherein the first end of each connecting sheet of the plurality of connecting sheets is hingedly mounted on the side wall of the main body, wherein the bottom portion of the main body further comprises a plurality of mounting shafts, wherein each mounting shaft of the plurality of mounting shafts penetrates through both the side wall of the main body and a corresponding connecting sheet of the plurality of connecting sheets.

3. The lighting apparatus of claim 2, wherein each connecting sheet of the plurality of connecting sheets comprises a separation through-slot for dividing each connecting sheet into at least two portions.

4. The lighting apparatus of claim 3, wherein the separation through-slot comprises two main portions spaced apart from each other on each connecting sheet, and a connecting portion between ends of the two main portions, wherein the two main portions extend along a length direction of each connecting sheet.

5. The lighting apparatus of claim 4, wherein each connecting sheet of the plurality of connecting sheets further comprises two bending through-slots, wherein the two bending through-slots are positioned on opposite sides of the separation through-slot.

6. The lighting apparatus of claim 3, wherein the separation through-slot extends along a length direction of each connecting sheet, wherein the separation through-slot comprises an opening at one end of the separation through-slot.

7. The lighting apparatus of claim 1, wherein the mounting frame comprises two parallel horizontal support plates spaced apart from each other, and a plurality of telescopic support rods disposed between the two horizontal support plates, wherein the plurality of mounting slots are disposed on the plurality of telescopic support rods.

8. The lighting apparatus of claim 7, wherein each horizontal support plate comprises a clearance notch, wherein a positioning flip plate for positioning the mounting frame is disposed at the clearance notch.

9. The lighting apparatus of claim 7, wherein each telescopic support rod of the plurality of telescopic support rods comprises a hollow tubular portion and a sliding portion, wherein the sliding portion is slidably disposed inside the hollow tubular portion.

10. The lighting apparatus of claim 1, wherein a housing of the main body comprises a wiring through-hole, wherein a sealing cover plate is disposed at the wiring through-hole, wherein a first end of the sealing cover plate is snap-fitted at the wiring through-hole and a second end of the sealing cover plate is fixedly pressed against an exterior of the main body by a fastener.

11. The lighting apparatus of claim 1, wherein the fans assembly comprises a first fans blade set and a second fans blade set, wherein the second fans blade set blows a heat dissipation air to the light source.

12. The lighting apparatus of claim 11, wherein the first fans blade set blows a main air flow outside the main body.

13. The lighting apparatus of claim 12, wherein the main air flow is larger than the heat dissipation air.

14. The lighting apparatus of claim 12, further comprising a switch to change wind direction of the main air flow.

15. The lighting apparatus of claim 14, wherein the switch is an IR receiver for receiving a command from a remote control.

16. The lighting apparatus of claim 15, wherein the switch toggles between a first wind direction and a second wind direction, wherein the first wind direction is opposite to the second wind direction.

17. The lighting apparatus of claim 16, wherein the switch is triggered when receiving a common IR signal.

18. The lighting apparatus of claim 17, wherein the common IR signal comprises multiple common IR signals for controlling other electrical appliances.

19. The lighting apparatus of claim 11, wherein the first fans blade set comprises a front blade and a rear blade, wherein the front blade is larger than the rear blade.

20. The lighting apparatus of claim 19, wherein the rear blade decreases a sound of the front blade when the front blade is rotating.
